(19) United States
(12) Patent Application Publication
(10) Pub. No.: US 2024/0006125 A1
(43) Pub. Date: Jan. 4, 2024

(54) Metallized Film DC-Link High Power Capacitors for High Frequency Applications

(71) Applicant: TDK Electronics AG, Munich (DE)

(72) Inventors: Manuel Gómez, CoÍn (ES); Fernando Rodriguez, Málaga (ES); Tomas Wagner, Málaga (ES); David Peláez, Torremolinos (ES)

(21) Appl. No.: 17/809,988

(22) Filed: Jun. 30, 2022

(51) Int. Cl. H01G 4/38; H01G 4/224; H01G 4/30

(52) U.S. Cl. CPC H01G 4/38; H01G 4/224; H01G 4/30

(57) ABSTRACT

In an embodiment a capacitor includes at least one capacitor unit, each capacitor unit including at least two winding elements, a first busbar, a second busbar, a third busbar and a fourth busbar, wherein all winding elements of the capacitor unit are arranged in a single stack, wherein the first busbar and the second busbar are arranged such that they overlap each other, wherein the first busbar and the second busbar are arranged at a first lateral face of the stack which has a surface normal perpendicular to a stacking direction of the stack, wherein, in the stacking direction, alternatingly either the first busbar or the second busbar is connected to a top face of the winding elements, wherein the third busbar and the fourth busbar are arranged such that they overlap each other, wherein the third busbar and the fourth busbar are arranged on a second lateral side of the stack opposite to a first lateral side, and wherein, in the stacking direction, alternatingly either the third busbar or the fourth busbar is connected to a bottom face of the winding elements.

### TECHNICAL FIELD

The present invention concerns a capacitor. In particular, the capacitor may be a metallized DC-link film capacitor.

### BACKGROUND

Metallized film DC-Link capacitors are critical components for many power electronics applications: renewable energies, electric vehicles, traction, motor drives, uninterruptible power supply, energy transmission, etc.

DC-Link capacitor requirements strongly depend on the parameters of a semiconductor implemented in a converter connected to the capacitor and a modulation strategy of the converter.

The development of Wide-bandgap semiconductors (WBGS), to higher on-state voltage, has changed the characteristics of high power converters: higher switching frequencies, higher harmonic frequencies, lighter cooling systems, higher power density, more compact designs, etc.

As a consequence, in order to work correctly in such applications, the capacitor should be able to be operated at high frequencies, e.g., frequencies above 10 kHz, without too many losses due to parasitic inductances and resistances.

### SUMMARY

Embodiments provide an improved capacitor, for example, a capacitor has low and internally homogeneous losses due to parasitic inductances and resistances at high switching frequencies.

A capacitor is provided that comprises at least two winding elements, a first busbar and a second busbar, wherein the first busbar and the second busbar connect the winding elements in parallel to each other and wherein the first busbar and the second busbar are arranged such that they overlap each other.

A winding element may be a capacitance unit. Each winding element of the capacitor may have the same capacitance. Each winding element may have a first pole of a first polarity, e.g., a positive polarity, and a second pole of a second polarity, e.g., a negative polarity. By applying a voltage between the first and the second pole, energy may be stored in the winding element.

A busbar may be a metallic strip or a metallic bar configured for local high current power distribution.

Due to the overlap of the first busbar and the second busbar, a capacitor is provided which has a characteristic that is well suited for power applications. When a current flows through the first busbar, a magnetic field is generated by the current. Further, when a current flows through the second busbar, another magnetic field is generated by this current. Due to the overlap of the busbars, the magnetic fields have opposite orientations and, therefore, weaken or even cancel each other. Thus, overall, only a very weak magnetic field may be generated, when a current is applied to the first busbar and the second busbar. This results in a small inductance of the connection of the busbars and between the winding elements. Thus, the inductance of the capacitor may also be very small.

A small inductance between the winding elements is important for a power capacitor as a high inductance would result in resonance effects and high losses due to parasitic inductances and resistances.

Overall, homogeneous impedance can be provided by each winding element having the same capacitance and by each connection from a terminal to a winding element having the same inductance. Due to design requirements, it may not always be possible to provide the same inductance for each winding element. Thus, instead of trying to adapt the inductances to each other, it is proposed to reduce the inductances to minimal values by cancelling or weakening the magnetic fields.

A capacitor with a first and a second busbar overlapping each other may have a low equivalent series resistance (ESR), a frequency-stable ESR, a low equivalent series inductance (ESL), and a homogeneous internal current distribution. Internal resonances may be avoided.

The first busbar and the second busbar may be arranged such that at least 20% of the area of the first busbar is overlapped by the second busbar. In the area of the overlap of the busbars, a thin isolator may be arranged between the busbars which prevents a short circuit between the busbars. The thin isolator may not significantly influence the magnetic fields.

The first busbar and the second busbar may be arranged such that a current flowing through the first busbar generates a first magnetic field and a current flowing through the second busbar generates a second magnetic field, wherein the first magnetic field and the second magnetic field compensate each other. The compensation of the magnetic fields may result in a low inductance and homogeneous impedance for all the winding elements. Thus, the capacitor may not show any resonance effects even when operated at switching frequencies above 10 kHz.

Each winding element may have a positive pole and a negative pole, wherein the first busbar is connected either to the positive pole of each winding element or to the negative pole of each winding element. The second busbar may be connected to the respective other of the positive pole of each winding element or the negative pole of each winding element. The busbars may be configured such that currents of opposite polarity flow in the busbars.

In one embodiment, the capacitor comprises a fifth busbar and a sixth busbar. The first busbar and the second busbar are arranged on a side of the stack and the fifth and the sixth busbar are arranged on a side of the stack opposite to the side at which the first busbar and the second busbar are arranged. The fifth busbar is connected to the same poles as the first busbar and the sixth busbar is connected to the same poles as the second busbar.

The first and the second busbar may be arranged on a lateral side of the stack which has a surface normal perpendicular to a stacking direction of the stack. The fifth busbar and the sixth busbar may be arranged on a lateral side opposite to the lateral side on which the first and the second busbar are arranged and which also has a surface normal perpendicular to the stacking direction.

The arrangement of the fifth and sixth busbar opposite to the first and second busbar may result in a symmetric coupling of currents into the winding elements. In particular, for each winding element, the first and the fifth busbar may be connected to one pole of the winding element and the second and sixth busbar may be connected to the other pole of the winding element.

The at least two winding elements may be arranged in a stack, wherein the first busbar and the second busbar are arranged at a lateral face of the stack. The lateral face of the stack may be a face that is perpendicular to a top face and a bottom face of the stack, wherein metallizations and connection elements for contacting the winding element are arranged on the top face and the bottom face of the winding elements. The top face of the stack may be formed by the top faces of the winding elements. The bottom face of the stack may be formed by the bottom faces of the winding elements.

The at least two winding elements may be arranged in a stack, wherein the first busbar and the second busbar are arranged on at least two faces of the stack. In particular, the first and the second busbar may completely or partly cover one or more lateral faces, and/or the top face and/or the bottom face of the stack.

All winding elements may be arranged in a single stack. The stack may comprise more than two winding elements.

In a stacking direction, the first busbar may be alternatingly connected to a top face of one winding element and to a bottom face of the next winding element. In the stacking direction, the second busbar may be alternatingly connected to a bottom face of one winding element and to a top face of the next winding element. Accordingly, the top face of each winding element is connected either to the first busbar or to the second busbar and the bottom face of each winding element is also connected either to the first busbar or the second busbar.

In the stack, the top faces of each winding element may face in the same direction. The bottom face of each winding element may be opposite to the top face of the winding element. The top faces of the winding elements may form the top face of the stack. The bottom faces of the winding elements may form the bottom face of the stack that is opposite to the top face of the stack.

In this embodiment, the windings are connected to both busbars in an alternate way. Thereby, the polarities of the winding elements alternate along the stacking direction. In other words, in the stacking direction, each winding element has an opposite polarity compared to the adjacent winding element.

As a result, the magnetic flux may be compensated in all connections, including the connection between winding elements. This may result in only very small parasitic inductances and resistances between winding elements and between winding elements and terminals. By reducing the parasitic inductances and resistances, the impedance from the terminals to each winding is more homogeneous between the winding elements for each frequency in the bandwidth in which the capacitor may be operated. Thus, the performance of the capacitor in the complete bandwidth is better due to a low and frequency stable ESR, a low ESL from each pair of terminals, an homogeneous internal current distribution and the avoidance of internal resonances.

In an alternative embodiment, the first busbar may be connected to a top face of each of the winding elements, and the second busbar may be connected to a bottom face of each of the winding elements.

The capacitor may comprise at least four winding elements, wherein at least two winding elements are arranged in a first stack and at least two winding elements are arranged in a second stack. The winding elements may be arranged in the first stack and, respectively, in the second stack such that the top face of the first stack has a polarity opposite to the polarity of the top face of the second stack. This arrangement of the winding elements in the stack may ensure that a current flows in an opposite direction in the overlapping busbars.

The first busbar and the second busbar may be arranged between the first stack and the second stack. This may facilitate contacting the first busbar and the second busbar to both of the first stack and the second stack.

The first busbar may have a larger thickness in a section between the stacks than in a section overlapping a top face or a bottom face of the winding elements. The second busbar may have a larger thickness in a section between the stacks than in a section overlapping a top face or a bottom face of the winding elements. The larger thickness between the stacks results in a high current capability of the capacitor. The low thickness in the sections overlapping the top or bottom faces ensures that the busbars can easily be fixed to the winding elements by welding.

The first busbar may be folded in the section between the stacks and/or the second busbar may be folded in the section between the stacks. The fold may be formed by a 180° turn of the respective busbar.

The winding elements may be arranged in the first stack and, respectively, in the second stack such that a top face of the first stack has a polarity opposite to the polarity of a top face of the second stack.

The first busbar may be connected to the top faces of the winding elements in the first stack and to the bottom faces of the winding elements in the second stack. The second busbar may be connected to the bottom faces of the winding elements in the first stack and to the top faces of the winding elements in the second stack. Thereby, it can be ensured that each winding element of the first stack is arranged adjacent to a winding element of the second stack which is inverted in its polarity with respect to the winding element of the first stack.

The first busbar may be arranged on the top face of the first stack and on the top face of the second stack and connected to the top faces of the winding elements in the first stack. The second busbar may be arranged on the top face of the first stack and on the top face of the second stack and connected to the top faces of the winding elements in the second stack. Accordingly, both of the first busbar and the second busbar may be arranged on the top faces of both stacks, resulting in a large overlap of the busbars.

Further, the capacitor may comprise a third busbar and a fourth busbar. The third busbar may be arranged on the bottom face of the first stack and on the bottom face of the second stack and connected to the bottom faces of the winding elements in the first stack. The fourth busbar may be arranged on the bottom face of the first stack and on the bottom face of the second stack and connected to the bottom faces of the winding elements in the second stack, wherein the third busbar and the fourth busbar overlap each other. Accordingly, both of the third busbar and the fourth busbar may be arranged on the bottom faces of both stacks, resulting in a large overlap of the busbars.

In one embodiment, the capacitor may comprise four busbars, wherein the busbars are arranged between the first stack and the second stack and wherein the busbars are connected to the winding elements such that a current flows in adjacent busbars in opposite directions. This arrangement of the busbars may result in a particularly well cancellation of the magnetic fields. The four busbars may be arranged such that each busbar connected to a pole of a first polarity is adjacent only to busbars connected to poles of the second polarity and, vice versa, each busbar connected to a pole of a second polarity is adjacent only to busbars connected to poles of the first polarity.

In particular, the first busbar may be connected to the top faces of the winding elements in the first stack having a first polarity. The second busbar may be connected to the top faces of the winding elements in the second stack having a second polarity opposite to the first polarity. The third busbar may be connected to the bottom faces of the winding elements in the second stack having the first polarity. The fourth busbar may be connected to the bottom faces of the winding elements in the first stack having the second polarity. The first busbar may be directly adjacent to the second busbar. The second busbar may be directly adjacent to the third busbar. The third busbar may be directly adjacent to the fourth busbar.

The first busbar may comprise two parts and/or the second busbar may comprise two parts. Each of the parts may have a Z-shaped cross-section. This design of the busbars may provide a particularly large overlapping area and, thus, a very effective cancellation of the electromagnetic flux. Thereby, low parasitic inductances and low parasitic resistances may be provided and negative electromagnetic interactions may be avoided.

The first busbar may be connected to the winding elements directly, e.g., by welding or soldering, and the second busbar may be connected to the winding elements directly, e.g., by welding or soldering. The direct connection reduces parasitic inductances and parasitic resistances and avoids negative electromagnetic interactions compared to a connection by connecting elements. However, in alternate embodiments, the busbars may be connected to the winding elements by connecting elements.

The first busbar may be formed such that it contacts two connection elements on a top face of each winding element, wherein the second busbar is formed such that it contacts two connection elements on a bottom face of each winding element, wherein the first and the second busbar each cover three lateral faces of the stack and the first busbar partly covers the top face of the stack and the second busbar partly covers the bottom face of the stack.

The capacitor may comprise at least four winding elements, wherein at least two winding elements are arranged in a first stack and at least two winding elements are arranged in a second stack, wherein the winding elements are arranged in the first stack and, respectively, in the second stack such that a top face of the first stack has a polarity opposite to the polarity of a top face of the second stack, wherein each of the first and the second busbar has a z-shaped cross-section, wherein the first busbar and the second busbar are arranged between the first stack and the second stack, wherein each of the first busbar and the second busbar partly covers the top face of the first stack and partly covers the bottom face of the second stack.

The winding elements have a non-circular diameter. In particular, the winding element may be flat. Flat winding elements may be arranged in a stack such that no space is wasted between the winding elements.

The capacitor may be a DC link capacitor. The capacitor can be any kind of capacitor. For example, the capacitor may be a film capacitor. The capacitor may be a power capacitor.

The film capacitor may comprise metallized films.

The capacitor comprises at least one capacitor unit. The capacitor unit comprises at least two winding elements, a first busbar, a second busbar, a third busbar and a fourth busbar, wherein all winding elements of the capacitor unit are arranged in a single stack, wherein the first busbar and the second busbar are arranged such that they overlap each other, wherein the first busbar and the second busbar are arranged at a lateral face of the stack which has a surface normal perpendicular to a stacking direction of the stack, wherein, in a stacking direction, alternatingly either the first busbar or the second busbar is connected to a top face of the winding elements, wherein the third busbar and the fourth busbar are arranged such that they overlap each other, wherein the third and the fourth busbar are arranged on a lateral side of the stack opposite to the lateral side at which the first busbar and the second busbar are arranged, wherein, in a stacking direction, alternatingly either the third busbar or the fourth busbar is connected to a bottom face of the winding elements, such that the third busbar is connected to the bottom faces of the winding elements which have a top face that is connected to the second busbar and that the fourth busbar is connected to the top faces of the winding elements which have a bottom face that is connected to the first busbar. For example, the capacitor unit may comprise four winding elements.

In an embodiment, the first busbar and the second busbar are arranged such that at least 20% of the area of the first busbar is overlapped by the second busbar, and the third busbar and the fourth busbar are arranged such that at least 20% of the area of the third busbar is overlapped by the fourth busbar.

In an embodiment, the first busbar and the second busbar are arranged such that a current flowing through the first busbar generates a first magnetic field and a current flowing through the second busbar generates a second magnetic field, wherein the first magnetic field and the second magnetic field compensate each other. In the embodiment, the third busbar and the fourth busbar are arranged such that a current flowing through the third busbar generates a third magnetic field and a current flowing through the fourth busbar generates a fourth magnetic field, wherein the third magnetic field and the fourth magnetic field compensate each other.

In an embodiment, each winding element has a “A” pole and a “B” pole, wherein the “A” poles of each winding element are connected either to the first busbar or to the third busbar, and wherein the “B” poles of each winding element are connected either to the second busbar or to the fourth busbar.

In an embodiment, each of the busbars is connected to the winding elements directly, e.g. by welding or soldering.

In an embodiment, each busbar of the capacitor unit is connected to the top face or to the bottom face of the respective winding element.

In an embodiment, each busbar comprises a terminal which is configured to be connected to an external connection.

In an embodiment, in the stacking direction of the stack, each winding element has an opposite polarity compared to the adjacent winding element.

In an embodiment, the winding elements are arranged in the stack such that the top faces of the winding elements are arranged at the first lateral side of the stack and the bottom faces of the winding elements are arranged at the second lateral side of the stack.

In an embodiment, the winding elements have a non-circular diameter.

In an embodiment, capacitor may be a DC link capacitor.

According to another aspect, The capacitor comprises two or more capacitor units, wherein each capacitor unit comprises at least two winding elements, e.g. four winding elements, a first busbar, a second busbar, a third busbar and a fourth busbar, wherein all winding elements of each capacitor unit are arranged in a single stack, wherein the first busbar and the second busbar are arranged such that they overlap each other, wherein the first busbar and the second busbar are arranged at a lateral face of the stack which has a surface normal perpendicular to a stacking direction of the stack, wherein, in a stacking direction, alternatingly either the first busbar or the second busbar is connected to a top face of the winding elements, wherein the third busbar and the fourth busbar are arranged such that they overlap each other, wherein the third and the fourth busbar are arranged on a lateral side of the stack opposite to the lateral side at which the first busbar and the second busbar are arranged, wherein, in a stacking direction, alternatingly either the third busbar or the fourth busbar is connected to a bottom face of the winding elements, such that the third busbar is connected to the bottom faces of the winding elements which have a top face that is connected to the second busbar and that the fourth busbar is connected to the top faces of the winding elements which have a bottom face that is connected to the first busbar.

In an embodiment, the two or more capacitor units are arranged such that the stacks of winding elements of each of the two or more capacitor units are arranged in a row wherein the stacking directions of the stacks are parallel to each other. Alternatively, the capacitor units may be arranged in multiple rows. For example, the capacitor may comprise four capacitor units, wherein two units are arranged in a first row and two units are arranged in a second row parallel to the first row. As another example, the capacitor may comprise six capacitor units, wherein three units are arranged in a first row and two units are arranged in a second row parallel to the first row. Moreover, other numbers of rows and capacitor units are also possible.

In an embodiment, the capacitor comprises an encapsulation which encloses the capacitor units.

In an embodiment, in each capacitor unit, each busbar of the capacitor unit is connected to the top face or to the bottom face of the respective winding element.

In an embodiment, each busbar comprises a terminal which is configured to be connected to an external connection.

In an embodiment, the capacitor may be a DC link capacitor.

### BRIEF DESCRIPTION OF THE DRAWINGS

In the following, the present invention is described with respect to the drawings:

FIGS. 1 to 42 show capacitors according to a first to thirteenth embodiments.

FIG. 43 shows a comparison of the ESR of a capacitor of the seventh embodiment and a reference capacitor.

FIG. 44 shows the reference capacitor.

FIGS. 45 to 102 show capacitor according to a fourteenth to twenty-fourth embodiment.

### DETAILED DESCRIPTION OF ILLUSTRATIVE EMBODIMENTS

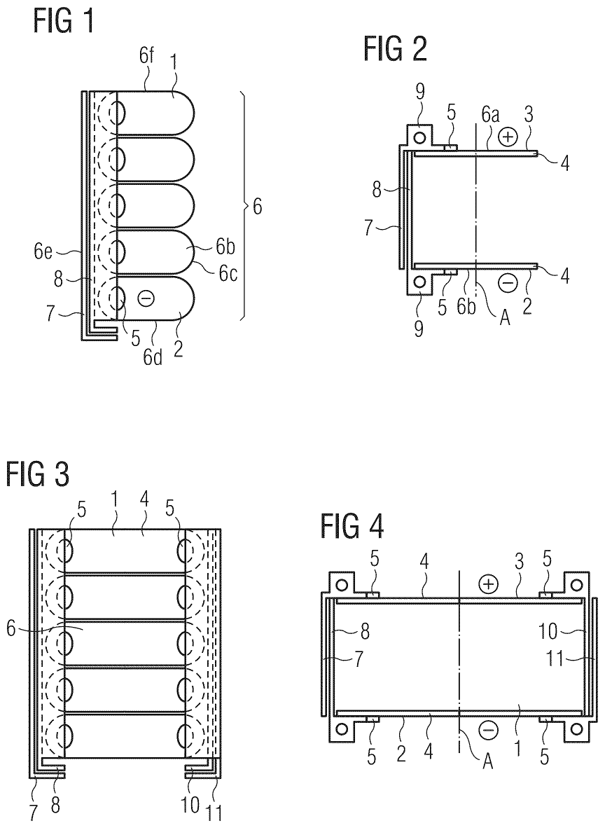

FIGS. 1 and 2 show a capacitor according to a first embodiment. FIG. 1 shows the capacitor in a bottom view and FIG. 2 shows the capacitor in a side view.

The capacitor is a DC link capacitor which is designed, for example, for voltages above 600 V and switching frequencies of more than 10 kHz.

The capacitor comprises a plurality of winding elements 1. In the embodiment shown in FIGS. 1 and 2, the capacitor comprises five winding elements 1. However, the capacitor may also comprise any other number of winding elements 1.

Each winding element 1 is wound around an axis A. The axis A extends from a bottom face 2 of the winding element 1 to a top face 3 of the winding element 1. The top face 3 of each winding element 1 is covered with a metallization 4, the so-called Schoop-layer. The metallization 4 of the top face 3 is connected to a first electrode or a first set of electrodes of the winding element. The bottom face 2 of each winding element 1 is also covered with a metallization 4, i.e., a Schoop-layer. The metallization 4 of the bottom face 3 is connected to a second electrode or a second set of electrodes of the winding element 1. The first electrode and the metallization 4 on the top face 3 or the first set of electrodes and the metallization 4 on the top face 3 form a first pole of the winding element 1. The second electrode and the metallization 4 on the bottom face 2 or the second set of electrodes and the metallization 4 on the bottom face 2 form a second pole of the winding element 1. During the operation of the capacitor 1, a voltage is applied between the first pole and the second pole.

For the sake of visualization, the first pole is marked with a “plus” in the drawings and the second pole is marked with a “minus”. As alternating currents are applied, the polarizations can be altered continuously.

On the top face 3 and on the bottom face 2 of each winding element 1a connection element 5, e.g., a connection stripe or a bonding wire, is arranged.

The winding elements 1 have a non-circular cross section. In particular, the winding elements 1 are flat.

The winding elements 1 are arranged in a stack 6. The winding elements 1 are arranged in the stack 6 such that the top face 3 of each winding element 1 faces in the same direction. The winding elements 1 are arranged in the stack 6 such that their axes A are parallel. A top face 6a of the stack 6 is formed by the top faces 3 of the winding elements 1. Further, a bottom face 6b of the stack 6 is formed by the bottom faces 2 of the winding elements 1. The bottom face 6b of the stack 6 is opposite to the top face 6a of the stack 6. Moreover, the stack 6 has four lateral faces 6c, 6d, 6e, 6f. Each of the lateral faces 6c, 6d, 6e, 6f is perpendicular to the top face 6a and to the bottom face 6b.

The capacitor comprises a first busbar 7 and a second busbar 8, which enable contacting the stack 6 of winding elements 1. In particular, the first busbar 7 is configured to apply a voltage to the first electrode or the first set of electrodes of each winding element 1. The second busbar 8 is configured to apply a voltage to the second electrode or the second set of electrodes of each winding elements 1.

The first busbar 7 is connected to the top face 3 of each winding element 1. In particular, the first busbar 7 is connected to the connection element 5 on the top face 3 of each winding element 1. The second busbar 8 is connected to the bottom face 2 of each winding element 1. In particular, the second busbar 8 is connected to the connection element 5 on the bottom face 2 of each winding element 1.

The first busbar 7 comprises at least one terminal 9. The first busbar 7 is configured to be connected to a pole of an external power supply, for example an insulated-gate bipolar transistor (IGBT), via the at least one terminal 9. The second busbar 8 also comprises at least one terminal 9. The second busbar 8 is configured to be connected to another pole of the external power supply, for example the insulated-gate bipolar transistor (IGBT), via the at least one terminal 9. Each of the first busbar 7 and the second busbar 8 can comprise more than one terminal 9.

In the first embodiment, the terminal 9 of the first busbar 7 is arranged at the top face 6a of the stack 6 and the terminal 9 of the second busbar 8 is arranged at the bottom face 6b of the stack 6. The first busbar 7 and the second busbar 8 are arranged at a lateral face 6e of the stack 6. Additionally, the first busbar 7 partly overlaps the top face 6a of the stack. The second busbar 8 partly overlaps the bottom face 6b of the stack 6.

The first busbar 7 and the second busbar 8 are arranged such that they overlap each other. A thin isolator plate is arranged between the first busbar 7 and the second busbar 8 in the area of the overlap of the busbars 7, 8. The thin isolator plate prevents a short circuit between the busbars. The thin isolator plate is not shown in FIGS. 1 and 2.

The first busbar 7 is configured to apply a voltage to the first electrode or the first set of electrodes of each winding element 1. The second busbar 8 is configured to apply a voltage to the second electrode or the second set of electrodes of each winding elements 1. As the first electrode and the second electrode or, respectively, the first set of electrodes and the second set of electrodes have an opposite polarity, a current flowing through the first busbar 7 and a current flowing through the second busbar 8 have an opposite direction.

The current flowing through the first busbar 7 generates a first magnetic field. The current flowing through the second busbar 8 generates a second magnetic field. As the first busbar 7 and the second busbar 8 overlap each other and as the currents in the first busbar 7 and the second busbar 8 have opposite directions, the magnetic fields generated in the first busbar 7 and in the second busbar 8 cancel each other or at least weaken each other.

Thus, the arrangement of the busbars 7, 8 overlapping each other results in reduced magnetic fields of the busbars 7, 8. Thereby, the inductance of the busbars 7, 8 is reduced. As the inductance from the busbar 7, 8 to each of the winding element 1 is very low and homogeneous and as each winding element 1 has the same capacitance, each winding element 1 has almost the same impedance. If the winding elements 1 had different impedances, resonance effects in the capacitor, in particular when applying high switching frequencies above 10 kHz, would be unavoidable. Due to the overlapping busbars 7, 8, the impedance for each winding element 1 is almost the same such that no significant resonance effects occur. Accordingly, the losses in the capacitor can be reduced. In particular, parasitic inductances and resistances are strongly reduced. The impedance from the terminal 9 to each winding element 1 is homogeneous in all the frequency bandwidths. This results in a low equivalent series resistance (ESR), a frequency stable ESR, a low equivalent series inductance (ESL) and the avoidance of an internal resonance. This enables the operation of the capacitor at voltages above 600 V and at switching frequencies of more than 10 kHz.

The use of the busbars 7, 8, which are connected to the connection elements 5 of each winding element 1 as shown in FIGS. 1 and 2 results in a homogeneous internal current distribution. In particular, the length along which the current has to travel through the busbars 7, 8 from the terminal 9 of the busbar 7, 8 to the connection element 5 is roughly the same. Due to the design of the capacitor it is not possible to design the busbar 7, 8 such that the length along which the current has to travel is identical for each winding element 1. However, as the inductance of the busbars 7, 8 is very low due to the cancelation of the magnetic fields, the differences in the length along which the current has to travel do not significantly impair the performance of the winding elements 1.

FIGS. 3 and 4 show a capacitor according to a second embodiment. FIG. 3 shows a bottom view of the capacitor and FIG. 4 shows a side view.

The capacitor according to the second embodiment comprises a fifth busbar 10 and a sixth busbar 11. The fifth 10 and the sixth busbars 11 are arranged at an opposite lateral side of the stack 6 with respect to the first busbar 7 and the second busbar 8.

In the capacitor of the second embodiment, each winding element 1 comprises two connection elements 5 arranged at its top face 3 and two connection elements 5 arranged at its bottom face 2. The connection elements 5 arranged at the top face 3 are both connected to the metallization 4 covering the top face 3 and, thereby, to the first electrode or, respectively, to the first set of electrodes. The connection elements 5 arranged at the bottom face 2 are both connected to the metallization 4 covering the bottom face 2 and, thereby, to the second electrode or, respectively, to the second set of electrodes.

The fifth busbar 10 is connected to the top face 3 of each winding element 1. In particular, the first busbar 7 is connected to one of the connection elements 5 on the top face 3 of each winding element 1 and the fifth busbar 10 is connected to the respective other connection element 5 on the top face 3 of each winding element 1.

The sixth busbar 11 is connected to the bottom face 2 of each winding element 1. In particular, the second busbar 8 is connected to one of the connection elements 5 on the bottom face 2 of each winding element 1 and the sixth busbar 11 is connected to the respective other connection element 5 on the bottom face 2 of each winding element 1.

Accordingly, according to the second embodiment, a current can be coupled into each winding element 1 to the first electrode or the first set of electrodes by the first busbar 7 and by the fifth busbar 10 and to the second electrode or the second set of electrodes by the second busbar 8 and by the sixth busbar 11. As the current is coupled into each pole of winding element 1 by two busbars at two points, the capacitor according to the second embodiment is configured to be operated by stronger currents than the capacitor according to the first embodiment.

The fifth and the sixth busbars 10, 11 overlap each other. Thus, their magnetic fields cancel or at least weaken each other. Therefore, the fifth and the sixth busbars 10, 11 also have a low inductance.

Moreover, the capacitor of the second embodiment is symmetric as the current can be induced into each pole of each winding element 1 from positions which are symmetric to each other. This symmetric design of the capacitor can further reduce resonance effects, thereby reducing losses due to parasitic impedances and resistances.

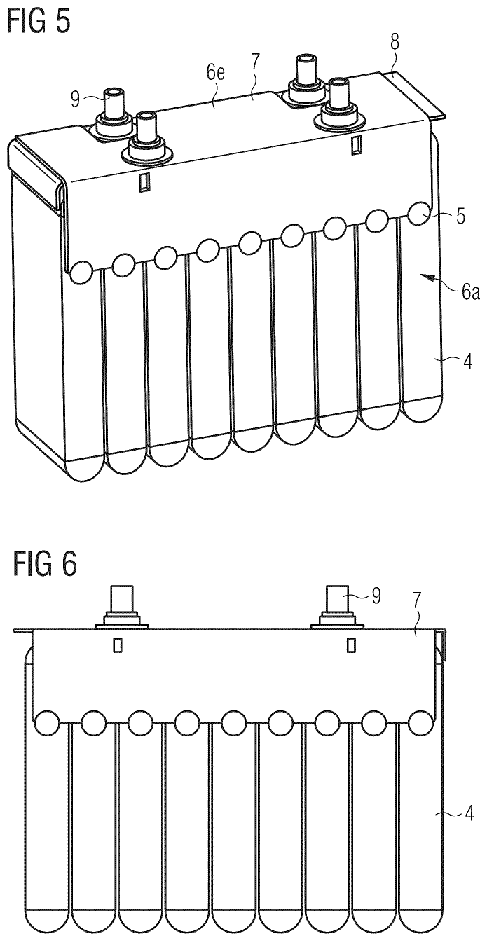

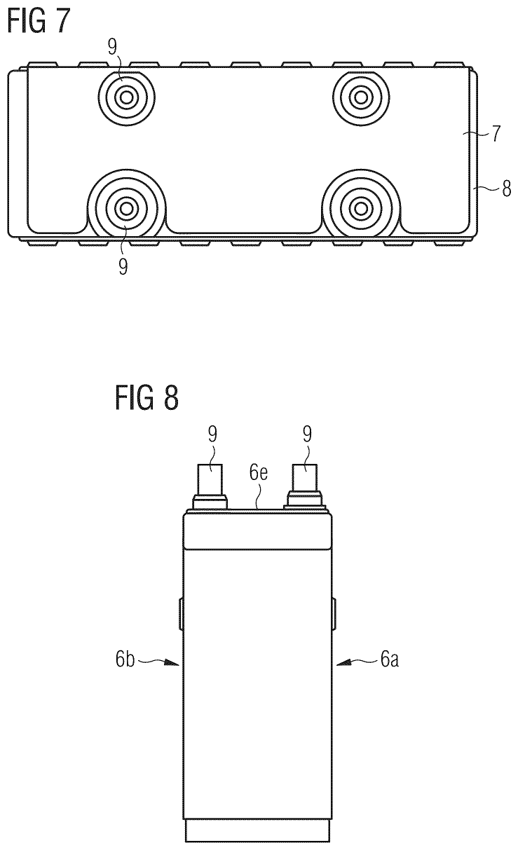

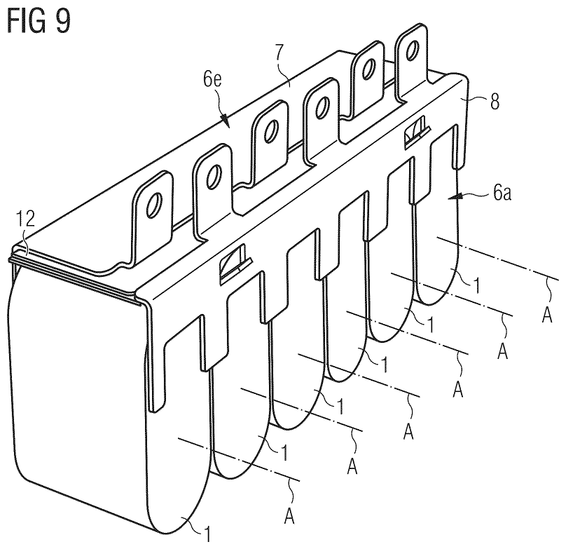

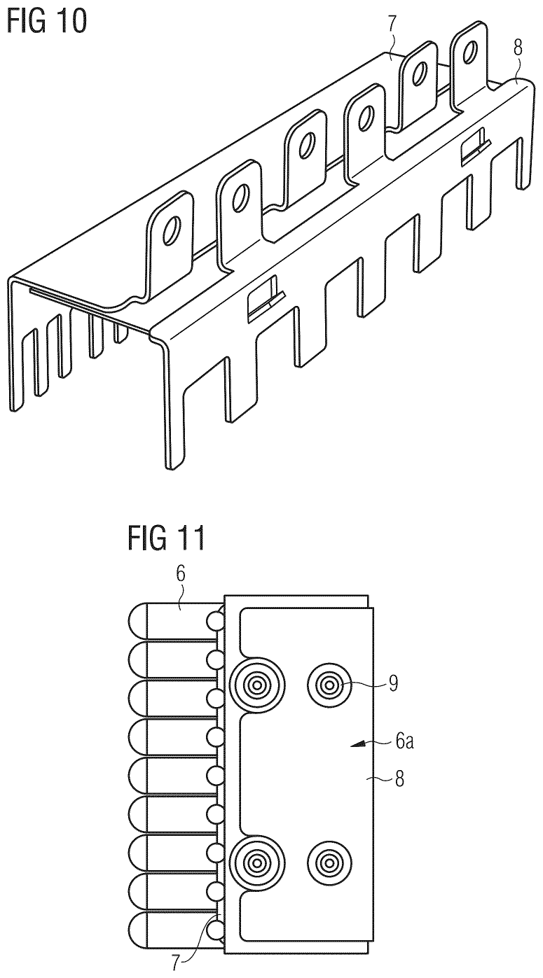

FIGS. 5 to 10 show a capacitor according to a third embodiment. FIG. 5 shows the capacitor in a perspective view. FIG. 6 shows the capacitor in a side view. FIG. 7 shows the capacitor in a top view. FIG. 8 shows the capacitor in another side view which is rotated by 90 degrees relative to FIG. 6. FIG. 9 shows the busbars 7, 8 and the winding elements 1 of the capacitor in a perspective view. FIG. 10 shows only the busbars 7, 8 in a perspective view.

The capacitor according to the third embodiment also comprises a first busbar 7 connected to the first electrode or the first set of electrodes of each winding element 1 and a second busbar 8 connected to the second electrode or the second set of electrodes of each winding element 1. The first busbar 7 and the second busbar 8 are both arranged on a first lateral face 6e of the stack 6. The first busbar 7 and the second busbar 8 overlap completely on the first lateral face 6e. Further, the first busbar 7 partly overlaps the top face 6a of the stack 6 and the second busbar 8 partly overlaps the bottom face 6b of the stack 6. The first busbar 7 is electrically connected to the metallization 4 on the top face 3 of each winding element 1. The second busbar 8 is electrically connected to the metallization 4 on the bottom face 2 of each winding element 1. As shown in FIG. 9, an isolator plate 12 is arranged between the first busbar 7 and the second busbar 8 in order to avoid a short circuit between the busbars. The isolator plate 12 is thin such that it does not influence the magnetic field significantly.

As already discussed with respect to the previous embodiments, due to the overlap of the busbars 7, 8, a magnetic field generated by a current flowing through the first busbar 7 is weakened or cancelled by a magnetic field generated by a current flowing through the second busbar 8, wherein the current through the second busbar 7 flows in a direction opposite to the current flowing through the first busbar 7. This results in a very low inductance.

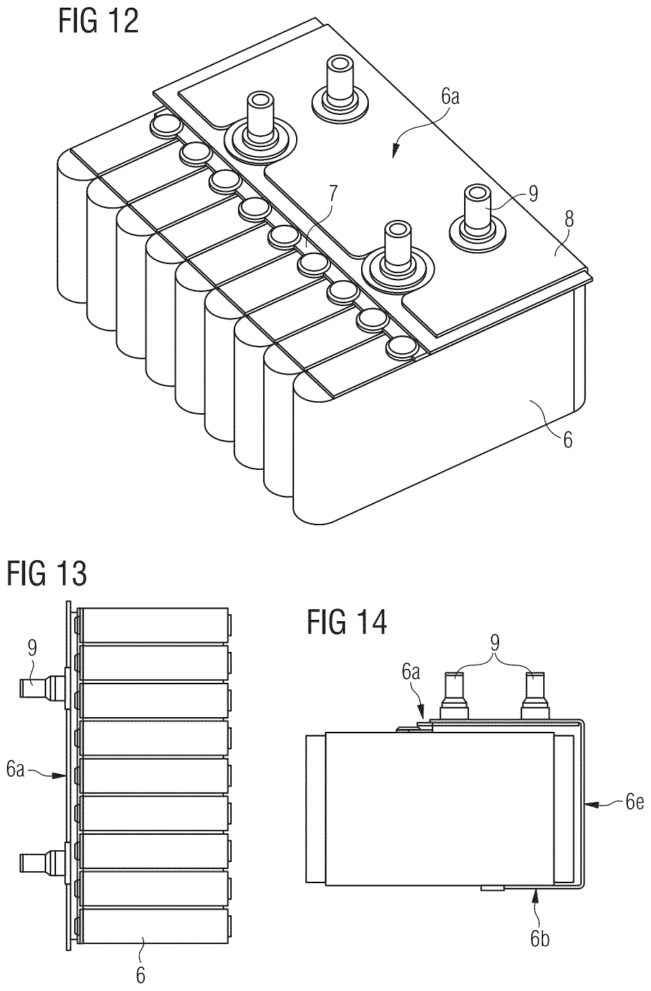

FIGS. 11 to 14 show a capacitor according to a fourth embodiment. Figure ii shows a top view of the capacitor. FIG. 12 shows a perspective view of the capacitor. FIG. 13 shows a side view and FIG. 14 shows another side view from a different angle. The capacitor according to the fourth embodiment differs from the third embodiment in the arrangement of the terminals 9 of the busbars 7, 8. According to the third embodiment, the terminals 9 are arranged on the first lateral face 6e of the stack 6. According to the fourth embodiment, the terminals 9 are arranged on the top face 6a of the stack 6.

Further, the first busbar 7 and the second busbar 8 are designed differently in the fourth embodiment. In particular, each of the first and second busbar 7, 8 is arranged such that it completely covers the first lateral face 6e of the stack 6 and that it partly covers the top face 6a and the bottom face 6b of the stack 6.

Moreover, the capacitor of the fourth embodiment differs from the previous embodiments in the number of winding elements 1. The capacitor of the fourth embodiment comprises nine winding elements 1. The capacitor can also be constructed with any other number of winding elements 1.

In the fourth embodiment, the first and the second busbar 7, 8 also overlap each other, resulting in a cancelation of weakening in the magnetic fields generated by currents flowing through the busbars 7, 8.

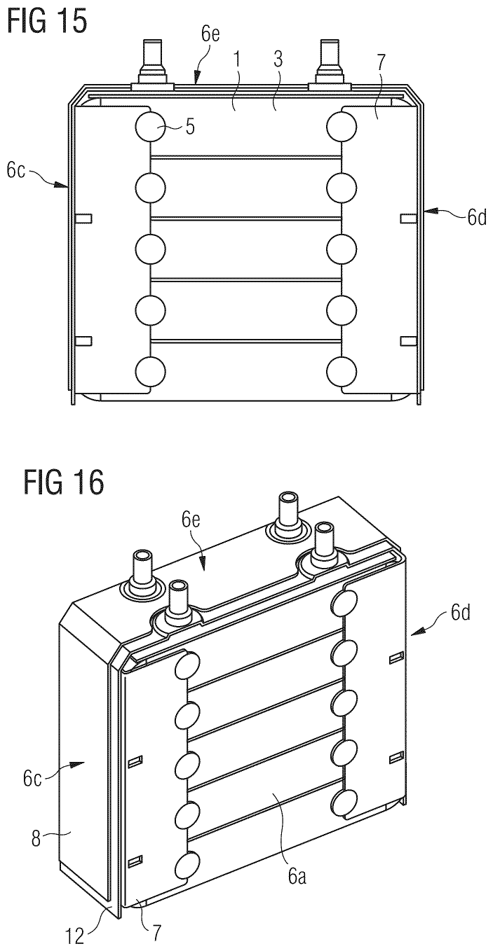

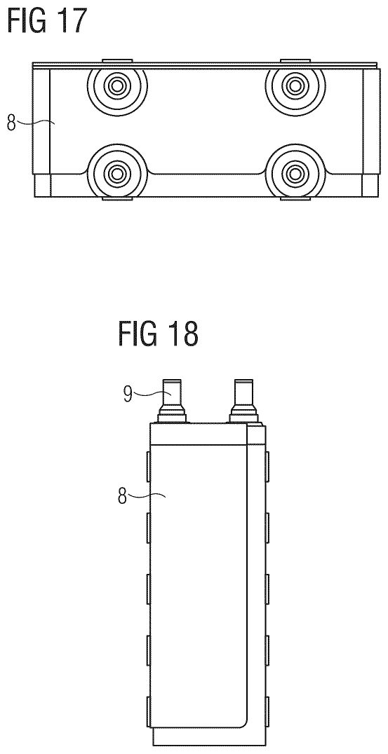

FIGS. 15 to 18 show a capacitor according to a fifth embodiment. The fifth embodiment differs in the design of the first busbar 7 and the second busbar 8 from the previous embodiments.

The busbars 7, 8 are connected to each winding element 1 at two points similar to the second embodiment. However, instead of providing two separate busbars 7, 8 which are connected to the same pole of each winding element 1 as shown in the second embodiment, the first busbar 7 is formed such that it contacts both of the connection elements 5 on the top face 3 of each winding element 1. The second busbar 8 is formed such that it contacts both of the connection elements 5 on the bottom face 2 of each winding element 1. The first and the second busbar 7, 8 completely cover three lateral faces 6c, 6d, 6e of the stack 6 and partly cover the top face 6a and the bottom face 6b of the stack 6.

The first and the second busbar 7, 8 overlap each other. In particular, the first busbar 7 and the second busbar 8 are arranged at almost identical positions. The second busbar 8 overlaps more than 90% of the area of the first busbar 7. The overlap of the busbars 7, 8 results in a very low inductance, as discussed above.

As discussed with respect to the second embodiment, the capacitor of the fifth embodiment is suitable for strong currents as the current is coupled via two connection elements 5 to each pole of each winding element 1.

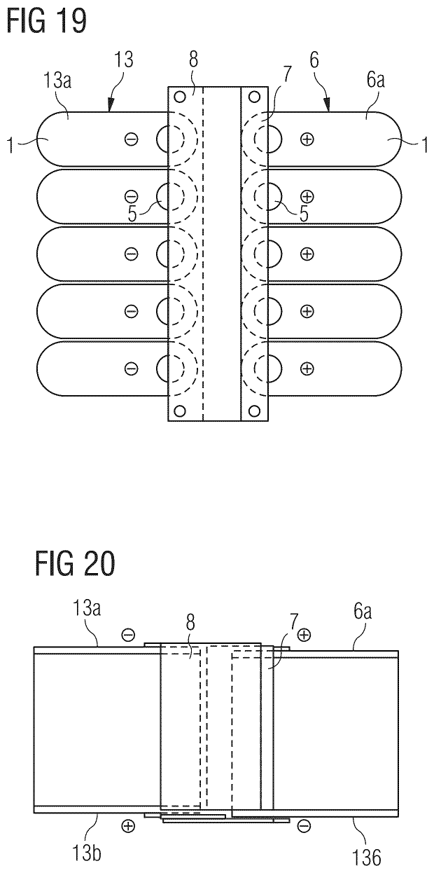

FIGS. 19 and 20 show a capacitor according to a sixth embodiment. FIG. 19 shows a top view of the capacitor and FIG. 20 shows a side view of the capacitor.

The capacitor comprises two stacks 6, 13, each stack 6, 13 consisting of a plurality of winding elements 1. The winding elements 1 in the first stack 6 are arranged such that they are inverted in their polarity compared to the adjacent winding elements 1 in the second stack 13. In particular, the top face 3 of the winding elements 1 of the first stack 6 corresponds to the first pole and the top face 3 of the winding elements 1 of the second stack 13 corresponds to the second pole.

The capacitor according to the sixth embodiment comprises a first busbar 7 and a second busbar 8. Each of the first and the second busbar 7, 8 has a z-shaped cross-section. Each of the first busbar 7 and the second busbar 8 is arranged between the two stacks 6, 13. Moreover, the first busbar 7 partly covers the top face 6a of the first stack 6 and partly covers the bottom face 13b of the second stack 13. The first busbar 7 is connected to the connection element 5 of each winding element 1 on the top face 6a of the first stack 6 and to each connection element 5 on the bottom face 13b of each winding element 1 in the second stack 13. Vice versa, the second busbar 8 is connected to each connection element 5 on the bottom face 2 of each winding element 1 of the first stack 6 and to the connection element 5 on the top face 3 of each winding element 1 of the second stack 13. The current flowing through the first busbar 7 is applied to the first pole of the first stack 6 and the first pole of the second stack 13 and the current flowing through the second busbar 8 is applied to the second pole of the first stack 6 and the second pole of the second stack 13. In the first stack 6, the first pole is arranged at the top face 6a of the stack 6 and in the second stack 13 the second pole is arranged at the top face of the second stack 13a. Accordingly, the currents flowing through the busbars 7, 8 flow in opposite directions, resulting in magnetic fields that cancel or weaken each other. Thereby, a capacitor having a very low inductance and homogeneous impedance between the winding elements is provided.

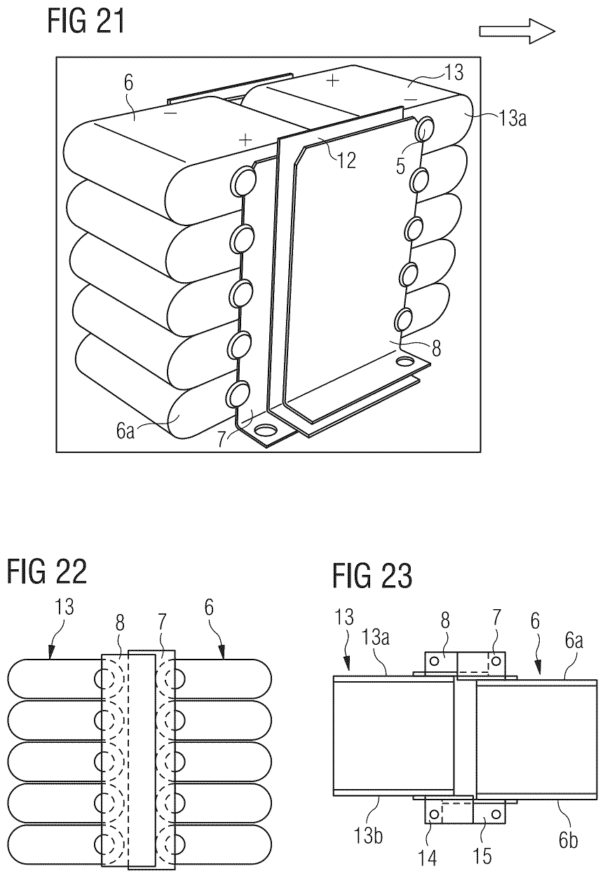

FIGS. 21 to 23 show a capacitor according to a seventh embodiment. FIG. 21 shows the capacitor in a perspective view. FIG. 22 shows the capacitor in a top view and FIG. 23 shows the capacitor in a side view.

The capacitor also comprises two stacks of winding elements 1 as already discussed with respect to the sixth embodiment. The design of the busbars is different in the seventh embodiment.

In the seventh embodiment, the first busbar 7 is arranged at the top faces 6a, 13a of both of the first stack 6 and the second stack 13. The first busbar 7 is connected only to the connection elements 5 on the top faces 3 of the winding elements 1 in the first stack 6. The first busbar 7 is not electrically connected to the top face 13a of the second stack 13. The second busbar 8 is connected only to the connection elements 5 on the top faces 3 of the winding elements 1 in the second stack 13. The second busbar 8 is not electrically connected to the top face 6a of the first stack 6. Moreover, both busbars 7, 8 overlap each other.

Additionally, the capacitor comprises a third busbar 14 which is connected to the connection elements 5 on the bottom face 13b of the second stack 13 and a fourth busbar 15 which is connected to the connection elements 5 on the bottom face 6b of the first stack 6. The third busbar 14 and the fourth busbar 15 are both arranged on the bottom faces 6b, 13b of both stacks 6, 13 and overlap each other.

The first busbar 7 and the third busbar 14 are configured to apply a current to the electrodes of the first pole. The second busbar 8 and the fourth busbar 15 are configured to apply a current to the electrodes of the second pole. The magnetic fields of the third busbar 14 and the fourth busbar 15 cancel or weaken each other as the busbars 14, 15 overlap each other and as the currents flow in opposite directions in the busbars 14, 15.

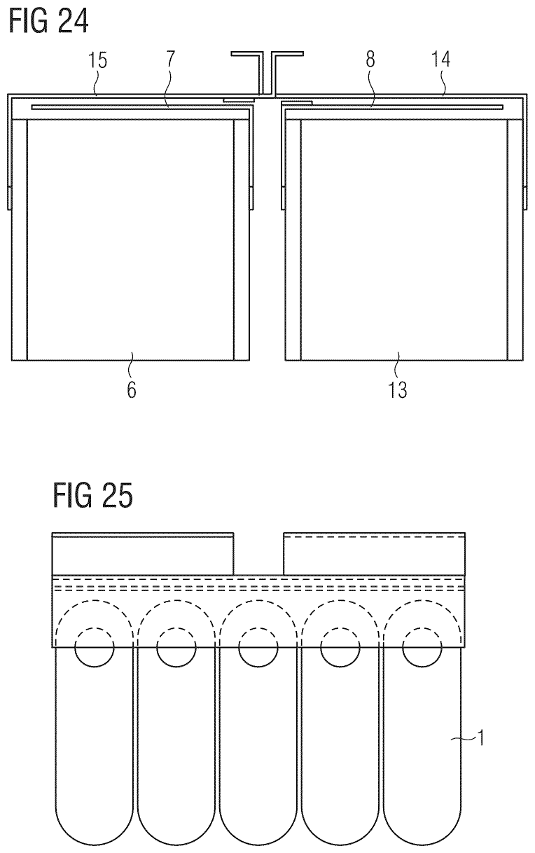

FIGS. 24 and 25 show a capacitor according to an eighth embodiment. The busbars 7, 8, 14, 15 of the eighth embodiments also overlap each other. The capacitor of the eight embodiment also comprises two stacks 6, 13 of winding elements 1. In contrast to the sixth and seventh embodiment, the winding elements 1 are rotated in the stacks by 90°.

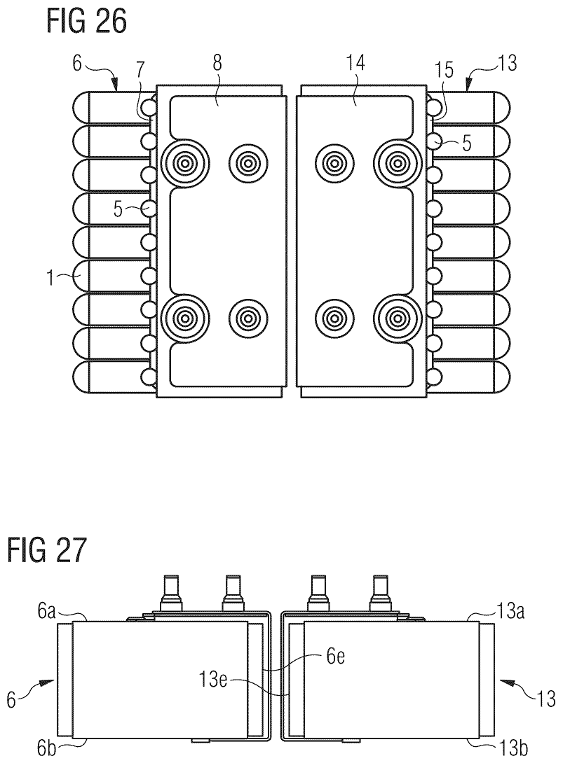

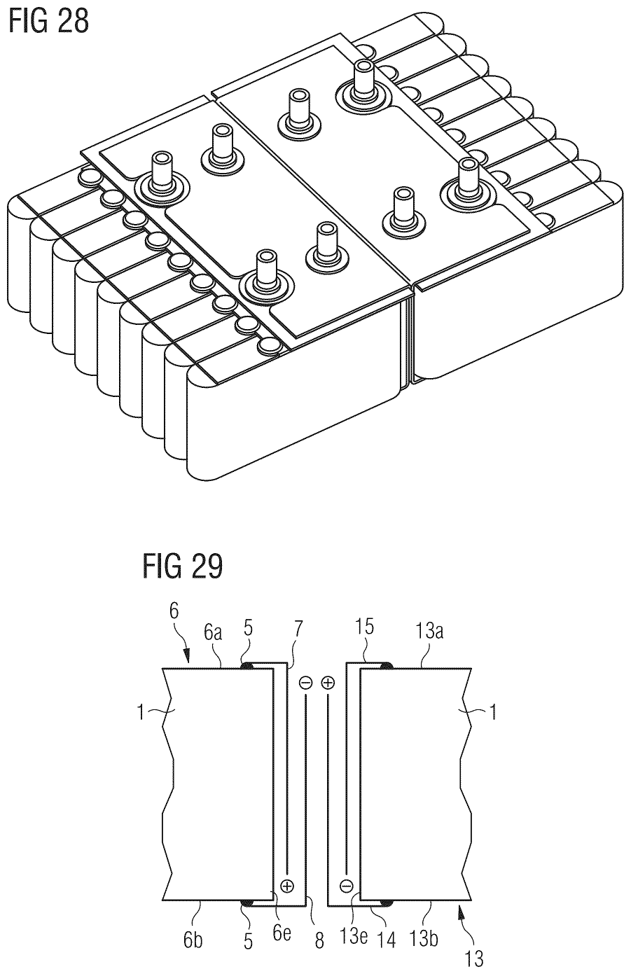

FIGS. 26 to 28 show a capacitor according to a ninth embodiment. FIG. 26 shows a top view of the capacitor, FIG. 27 shows a side view of the capacitor and FIG. 28 shows a perspective view of the capacitor.

The capacitor comprises four busbars 7, 8, 14, 15. Moreover, the capacitor comprises two stacks 6, 13 of winding elements 1. The first busbar 7 and the second busbar 8 are arranged at a lateral side 6e of the first stack 6 of winding elements 1. Moreover, the first busbar 7 and the second busbar 8 partly cover the top face 6a and the bottom face 6b of the first stack 6. The first busbar 7 is connected to the connection elements 5 on the top face 3 of the winding elements 1 of the first stack 6. The second busbar 8 is connected to the connection elements 5 on the bottom face 6b of the first stack 6.

Further, a third busbar 14 and a fourth busbar 15 are arranged on a lateral face 13e of the second stack 13. In particular, the third busbar 14 and the fourth busbar 15 are arranged on the lateral face 13e which is directly adjacent to the lateral face 6e of the first stack 6 on which the first and the second busbar 7, 8 are arranged. The third busbar 14 is connected to the connection elements 5 on the bottom face 13b of the second stack 13. The fourth busbar 15 is connected to the connection elements 5 on the top face 13a of the second stack 13.

FIG. 29 shows a schematic view explaining the connections of the busbars 7, 8, 14, 15 and the winding elements 1. For the sake of simplicity, the first pole is marked again with a “plus” and the second pole is again marked with a “minus” in FIG. 29. It can be seen in FIG. 29 that busbars having opposite polarities are arranged adjacent to each other. In particular, each busbar has an opposite polarity with respect to its adjacent busbars. Thus, as the four busbars 7, 8, 14, 15 overlap in the gap between the two stacks 6, 13, it is ensured that their magnetic fields cancel each other very efficiently. This design results in an even lower inductance and an even more homogeneous impedance between the winding elements.

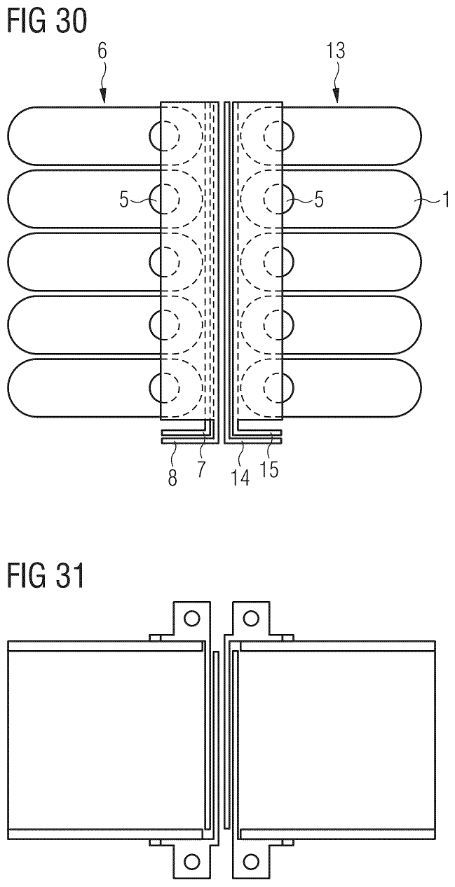

FIGS. 30 and 31 show a capacitor according to a tenth embodiment. The capacitor of the tenth embodiment also comprises two parallel stacks 6, 13 of winding elements 1 and four busbars 7, 8, 14, 15 arranged between the winding elements 1. The capacitor according to the tenth embodiment differs from the capacitor according to the ninth embodiment only in the arrangement of the terminals 9 of the busbar.

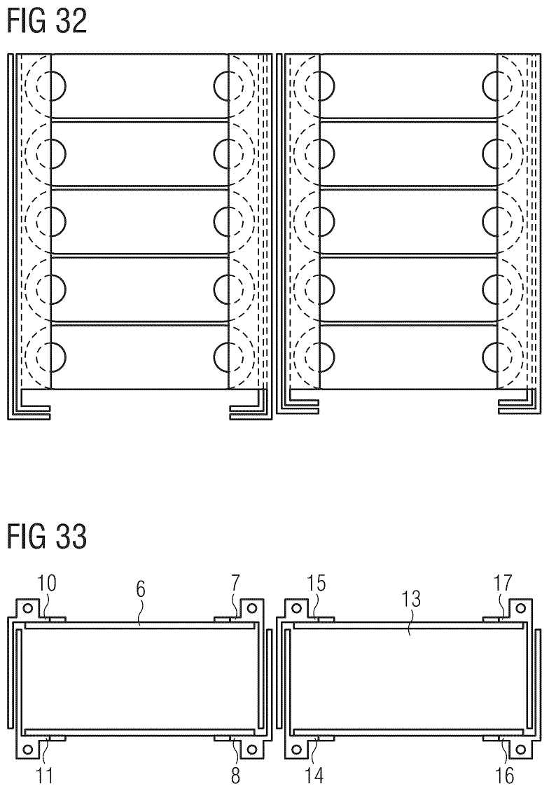

FIGS. 32 and 33 show a capacitor according to an eleventh embodiment. The capacitor according to the eleventh embodiment is based on the capacitor according to the tenth embodiment and additionally comprises a fifth and sixth busbar 10, 11 arranged at a lateral face 6f of the first stack 6 and a seventh and eighth busbar 16, 17 arranged at a lateral face 13f of the second stack 13. The capacitor according to the eleventh embodiment is designed to apply a current to each pole of each stack 6, 13 at two positions, thereby enabling the application of stronger currents similar to the second embodiment. This capacitor further provides a high degree of symmetry, resulting in even fewer resonance effects. Thereby, losses due to parasitic inductances and resistances are further reduced.

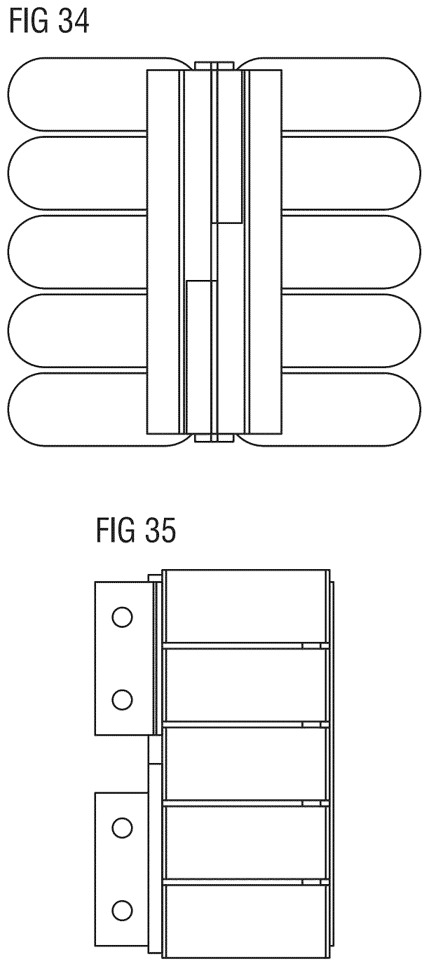

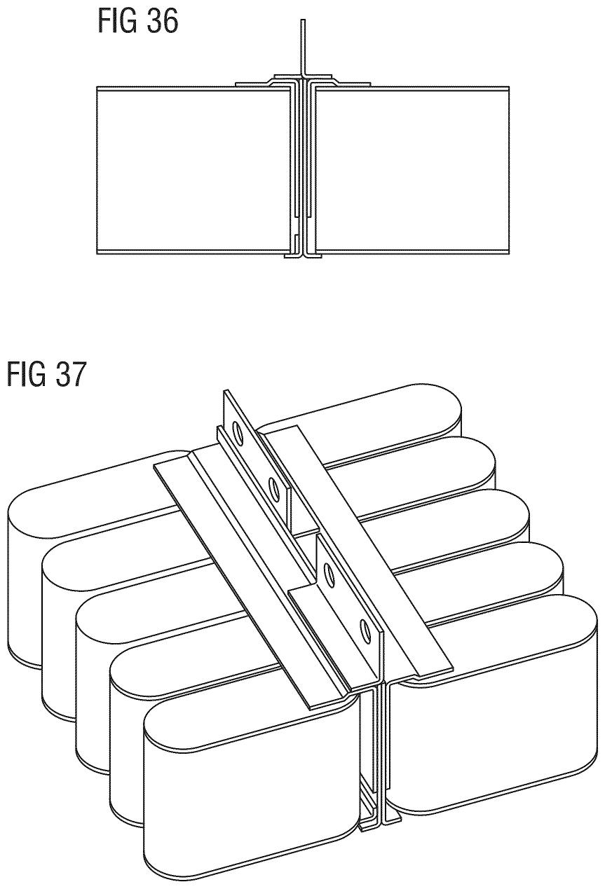

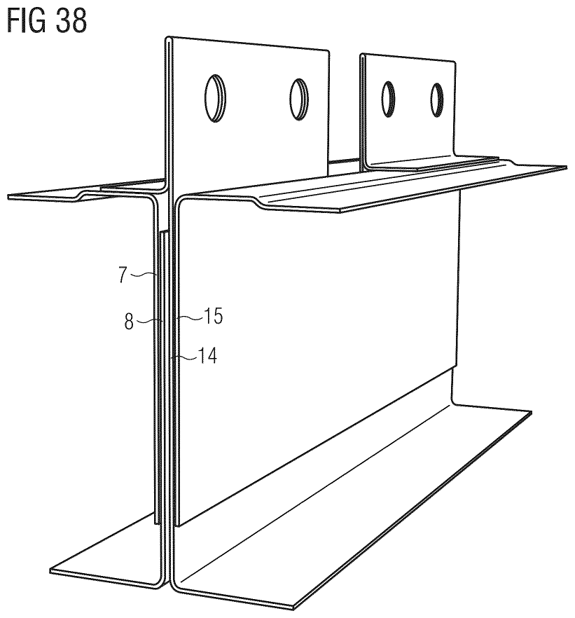

FIGS. 34 to 37 show a capacitor according to a twelfth embodiment. FIG. 38 shows the busbars 7, 8, 14, 15 of the capacitor of the twelfth embodiment. FIG. 39 also shows a perspective view of the busbars 7, 8, 14, 15 of the twelfth embodiment from a different perspective. The busbars 7, 8, 14, 15 are bent and folded such that a stack is formed wherein alternatively busbars of the first polarity and busbars of the second polarity are arranged overlapping each other and can be seen best in FIG. 39. Thin isolation plates 12 are arranged between the busbars 7, 8, 14, 15 in order to prevent a short circuit. As discussed with respect to the previous embodiments, this design of the busbars 7, 8, 14, 15 also ensures that the magnetic fields cancel each other resulting in a low inductance. For the sake of simplicity, the isolator plates are not shown in FIG. 38.

In the gap between the first stack 6 and the second stack 13, four layers of overlapping busbars are arranged. The magnetic fields of the four layers of busbars cancel each other. Thus, parasitic inductances are avoided, parasitic resonances are avoided and negative electromagnetic interactions are also avoided.

The first busbar 7 and the second busbar 8 are connected to the winding elements 1 directly, e.g., by soldering or welding. No extra or separate connection elements are required for connecting the busbars 7, 8 to the winding elements 1. Such extra or separate connection elements would result in increased parasitic inductances, increased parasitic resonances and the generation of negative electromagnetic interactions. As the capacitor is free from extra or separate connection elements between the first and second busbar 7, 8 and the winding elements 1, parasitic inductances are avoided, parasitic resonances are avoided and negative electromagnetic interactions are also avoided.

The busbars 7, 8 can be designed and dimensioned such that the busbars 7, 8 are connected to a middle point of the top face 3 of the winding elements 1 and to a middle point of the bottom face 2 of the winding elements 1. This design of the busbars 7, 8 results in a high current capability and allows using winding elements 1 with a large maximum size.

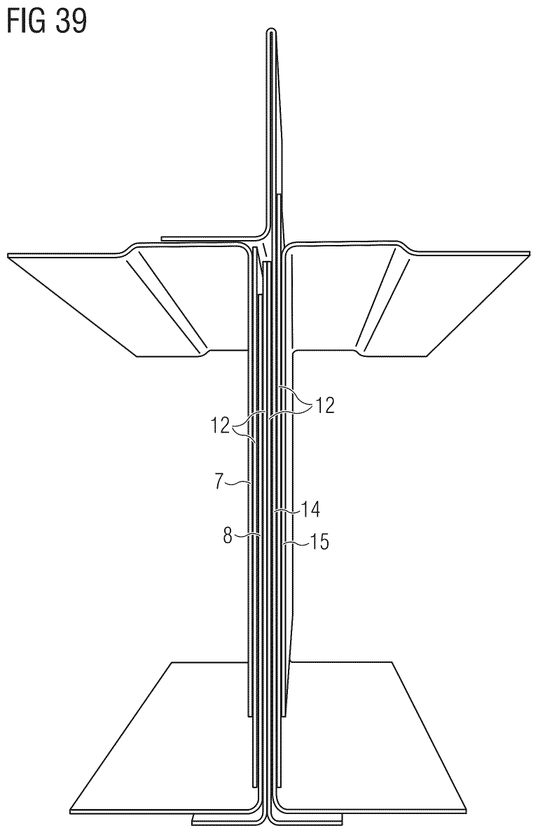

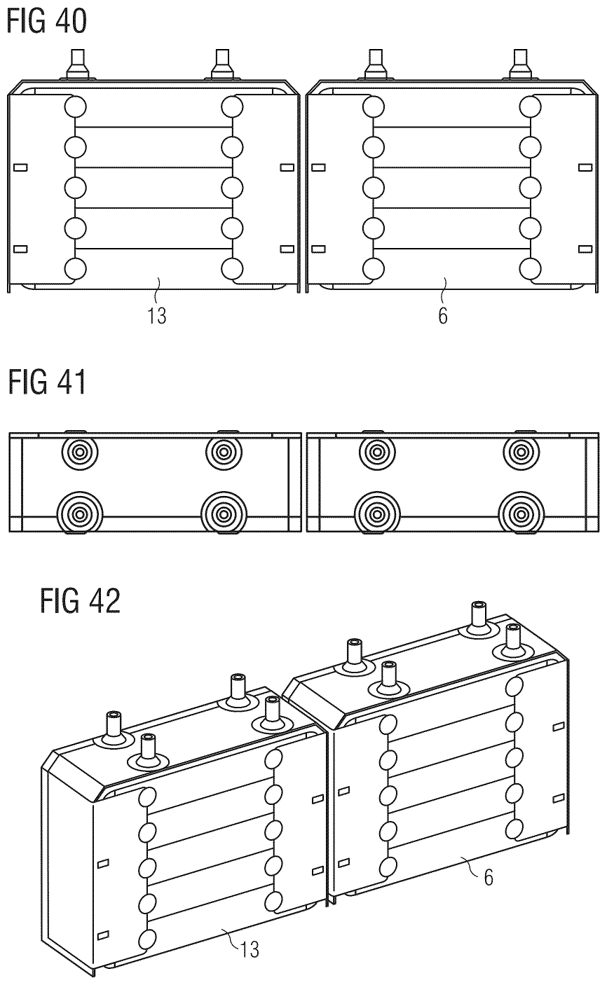

FIGS. 40 to 42 show a capacitor according to a thirteenth embodiment. The capacitor according to the thirteenth embodiment results in two capacitors according to the fifth embodiment being arranged side by side and forming two stacks 6, 13 of winding elements 1 wherein in the second stack 13 the winding elements 1 are arranged oppositely with respect to their polarity. Again, the busbars 7, 8, 14, 15 having opposite polarities overlap each other, resulting in a cancellation or weakening of the respective magnetic fields.

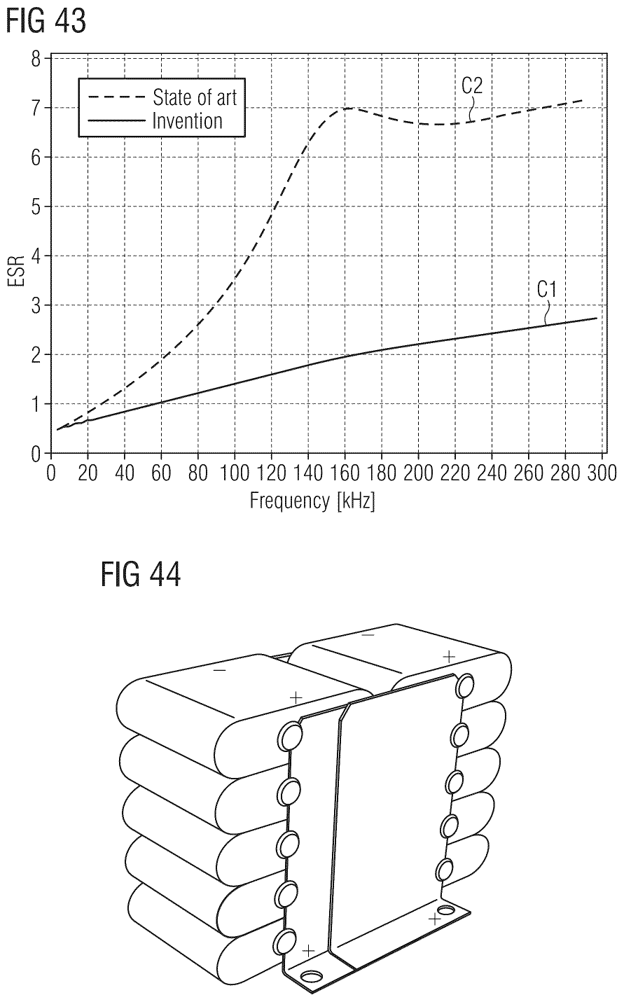

FIG. 43 shows a plot of the ESR over the frequency of a capacitor according to the seventh embodiment of the present invention represented by curve C1 compared to a reference capacitor as shown in FIG. 44 wherein busbars of opposite polarities do not overlap each other represented by curve C2. It can be seen in FIG. 43 that the ESR of the reference capacitor is higher than the ESR of the capacitor according to the seventh embodiment and that it is less frequency-stable due to a non-homogeneous internal current distribution and internal resonances. In particular, at frequencies higher than 10 KHz, a significant reduction in the ESR can be observed in the capacitor according to the seventh embodiment.

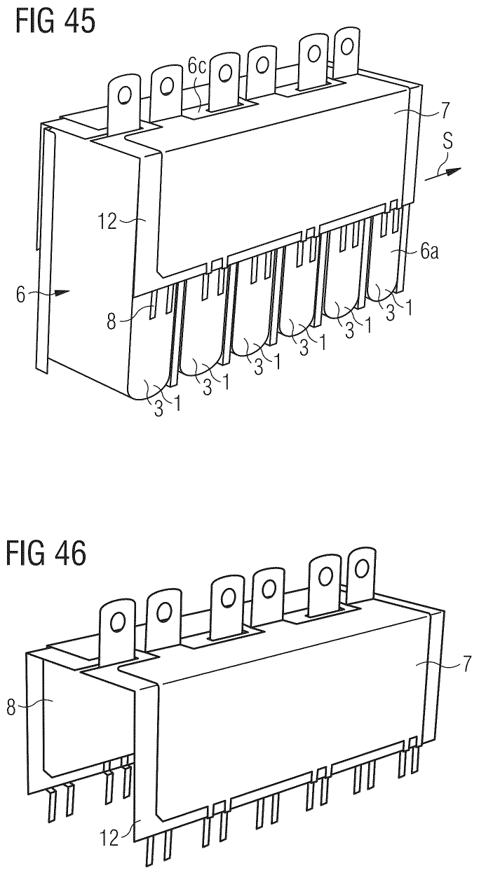

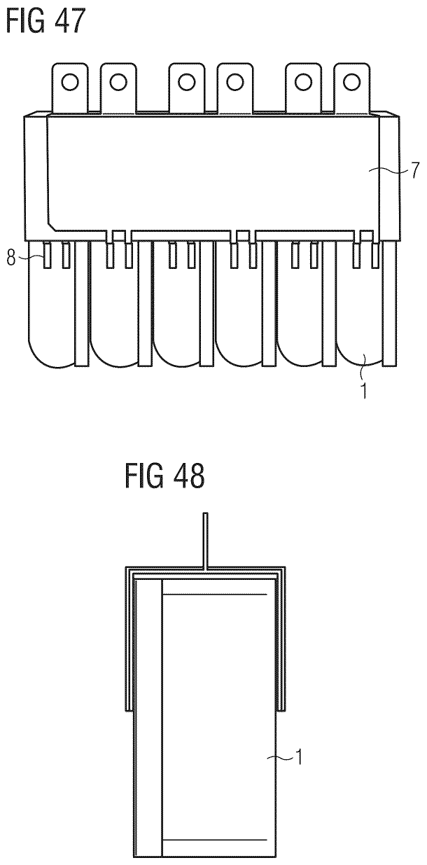

FIGS. 45 to 48 show a capacitor according to a fourteenth embodiment. FIGS. 45, 47 and 48 show perspective views of the capacitor according to a fourteenth embodiment. FIG. 46 shows the first and the second busbar 7, 8 of the capacitor. Moreover, FIG. 46 shows an isolator plate 12 being arranged between the busbars 7, 8.

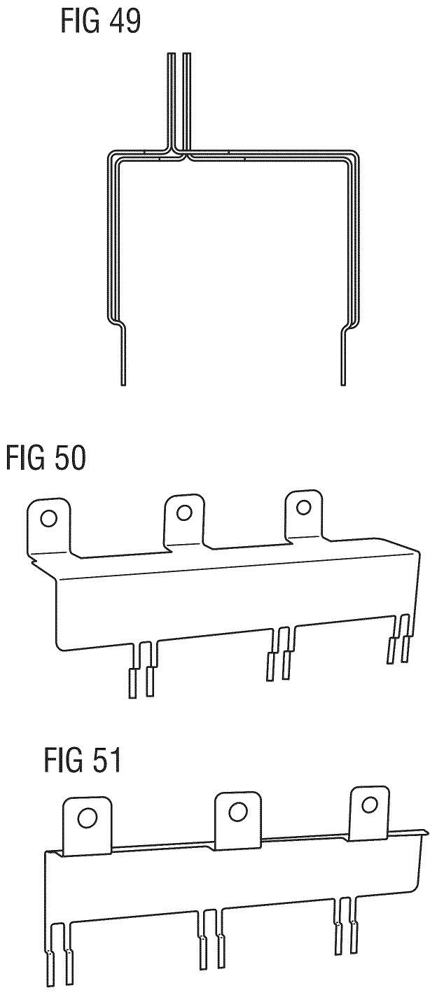

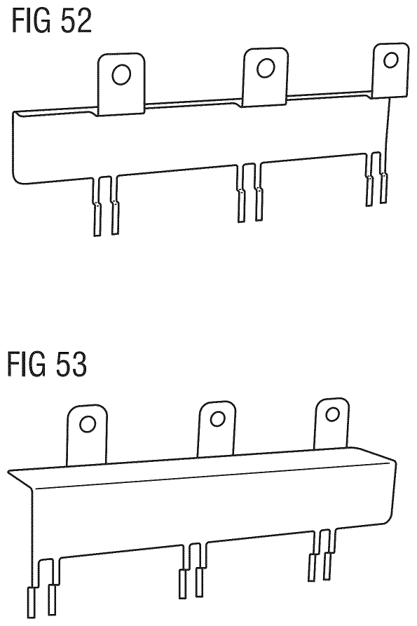

FIG. 49 shows the first busbar 7 and the second busbar 8. Each of the first busbar 7 and the second busbar 8 comprises two parts. A first part 7a of the first busbar 7 is shown in FIG. 50. A second part 7b of the first busbar 7 is shown in FIG. 51. A first part 8a of the second busbar 8 is shown in FIG. 52. A second part 8b of the second busbar 8 is shown in FIG. 53.

The winding elements 1 of the capacitor are arranged in a single stack 6. In a stacking directions S, the winding elements 1 alternate regarding their polarity.

The first busbar 7 and the second busbar 8 are both arranged on a lateral face 6c of the stack 6. The first busbar 7 and the second busbar 8 overlap each other on the lateral face 6a of the stack. Further, each of the first busbar 7 and the second busbar 8 overlaps with the top face 6a of the stack 6 and with the bottom face 6b of the stack 6.

When an alternating current is applied to the capacitor, the currents in the overlap of the first busbar 7 and the second busbar 8 have opposite directions. Thus, parasitic inductances, parasitic resistances and negative electromagnetic interactions are low.

In the stacking direction S, the first busbar 7 is alternatingly connected to the top face 3 of one winding element 1 and to the bottom face 2 of the adjacent winding element 1. The second busbar 8 is connected to the respective other face, i.e., the 9 of the one winding element 1 and the top face 2 of the adjacent winding element 1. This connection of the two busbars 7, 8 to the winding elements 1 in an alternating manner results in the winding elements 1 having alternating polarities along the stacking direction S. Thereby, the magnetic flux of adjacent winding elements 1 can compensate each other. The compensation of the magnetic flux results in a low parasitic inductance, a low parasitic resistance and low negative electromagnetic interactions.

Due to the compensation of the magnetic flux, the parasitic inductances and resistances between the winding elements 1 and between the winding elements 1 and the terminals are reduced. Thereby, the impedance from the terminals 9 to each winding element 1 is more homogeneous between winding elements 1 in all the bandwidth, so the performance of the capacitor in all the bandwidth is better. In particular, the capacitor has a low and frequency stable ESR, a low ESL from each pair of terminals, a homogeneous internal current distribution and internal resonances are avoided.

As mentioned above, each of the first busbar 7 and the second busbar 8 consists of two parts. The two parts 7a,m 7b of the first busbar 7 each have a Z-shaped cross-section.

The first part 7a comprises a first section 18, a second section 19 and a third section 20. The second section 19 is arranged between the first section 18 and the third section 20. The second section 19 is perpendicular to each of the first section 18 and the third section 20. The first section 18 and the third section 20 are parallel to each other. This design of the first section 18, the second section 19 and the third 20 section results in the Z-shaped cross section of the first part 7a of the first busbar 7.

The first section 18 of the first part 7a is part of the terminal 9 of the first busbar 7. The second section 19 of the first part 7a is arranged on the lateral face 6c of the stack 6. The third section 20 of the first part 7a is arranged on the bottom face 6b of the stack 6. The third section 20 comprises a pair of two protrusions 21 that are electrically and mechanically connected to the bottom face 2 of a winding element 1. In particular, the third section 20 comprises multiple pairs of two protrusions 21 that are electrically and mechanically connected to the bottom face 2 of every second winding element 1 in the stacking direction S.

The second part 7b of the first busbar 7 is designed analog to the first part 7a of the first busbar 7. In particular, the second part 7b also comprises a first section 18, a second section 19 and a third section 20. The second part 7b also has a Z-shaped cross-section.

The first section 18 of the second part 7b of the first busbar 7 is part of the terminal 9 of the first busbar 7. In particular, the terminal 9 is formed by the two first sections 18 of the first part 7a and of the second part 7b. The second section 19 of the second part 7b is perpendicular to the first section 18 and is arranged on the lateral face 6c of the stack 6. The third section 20 of the second part 7b is perpendicular to the second section 19 and is arranged on the top face 6a of the stack 6. The third section 20 comprises a pair of two protrusions 21 that are electrically and mechanically connected to the top face 3 of a winding element 1. In particular, the third section 20 comprises multiple pairs of two protrusions 21 that are electrically and mechanically connected to the top faces 2 of those winding element 1 which have a bottom face 2 that is not connected to the first part 7a.

The first and the second part 8a, 8b of the second busbar 8 are formed analog to the first and second part 7a, 7b of the first busbar 7 and are, therefore, not described in detail.

The first busbar 7 and the second busbar 8 completely overlap each other apart from the protrusions 21 that are connected to the tope face 3 or the bottom face 2 of the winding elements 1. Thus, the protrusions 21 are the only parts of the busbars 7, 8 wherein the electromagnetic flux of the two busbars 7, 8 is not compensated by the respective other busbar. Overall, this results in a very large compensation of the electromagnetic flus in the busbars 7, 8.

Each of the first busbar 7 and the second busbar 8 comprises multiple terminals 9. The terminals 9 are distributed symmetric with respect to the winding elements 1 along the first busbar 7 and the second busbar 8. The symmetric arrangement of the terminals 9 optimizes a current balance between the winding elements 1. A non-symmetric arrangement of the terminals 9 would result in an unbalanced current between the winding elements 1 and, thus, a reduced performance of the capacitor.

When an alternating current is applied to the terminals 9 of the first busbar 7 and the second busbar 8, the alternating current flows through each of the first part 7a and the second part 7b of the first busbar 7 and the first part 8a and the second part 8b of the second busbar 8.

The Z-shaped cross-section of each of the parts 7a, 7b, 8a, 8b of the busbars 7, 8 results in a large overlapping area of the busbars 7, 8. Thus, due to the large overlap, the parasitic inductances are very low, the parasitic resistances are very low and negative electromagnetic interactions can be avoided.

The first busbar 7 and the second busbar 8 are electrically connected to the middle points of the top face 3 or the bottom face 2 of the winding elements 1. The busbars 7, 8 can be adapted to the dimensions of the winding elements 1 and can, in particular, be dimensioned such that they are connected to the middle points of the top face 3 or, respectively, the bottom face 2 of the winding elements 1 independently of the dimensions of the winding elements 1. This increases the current capability and the allowed maximum winding size.

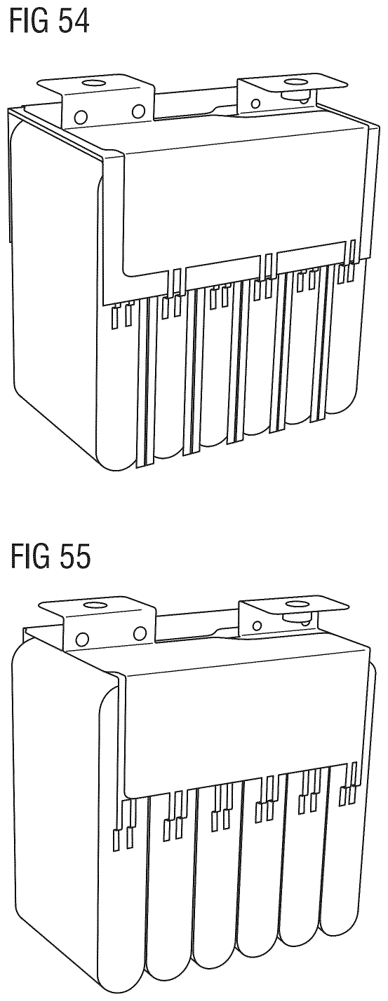

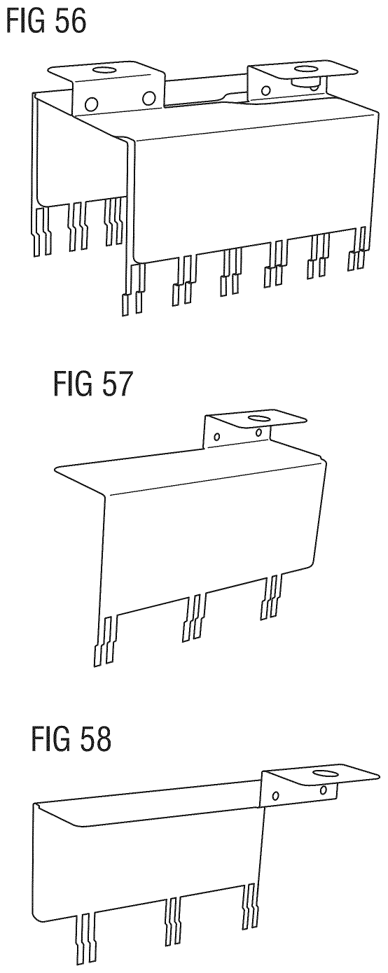

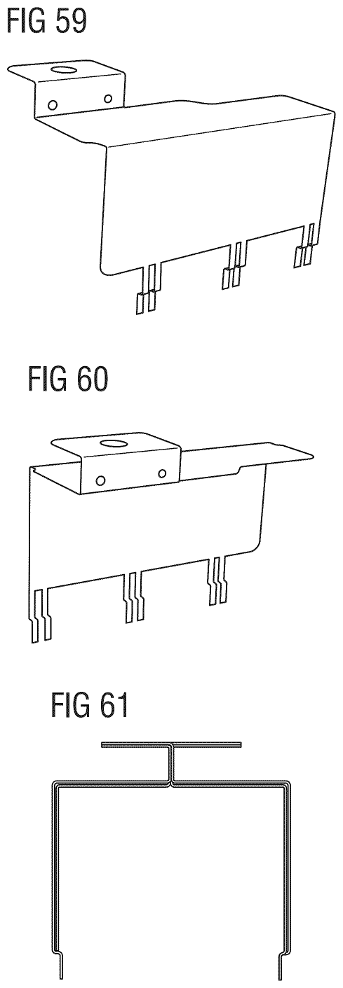

FIGS. 54 and 55 show a capacitor according to a fifteenth embodiment. FIG. 56 shows the busbars 7, 8 of the capacitor according to the fifteenth embodiment in a perspective view. FIG. 57 shows a first part 7a of the first busbar 7. A second part 7b of the first busbar 7 is shown in FIG. 58. A first part 8a of the second busbar 8 is shown in FIG. 59. A second part 8b of the second busbar 8 is shown in FIG. 6o. FIG. 61 shows the first busbar 7 and the second busbar 8 in a cross-sectional view.

The capacitor of the fifteenth embodiment is substantially identical to the capacitor of the fourteenth embodiment and differs from the capacitor of the fourteenth embodiment only in the shape and the number of the terminals 9. According to the fifteenth embodiment, each of the first busbar 7 and the second busbar 8 has only one terminal 9. The terminal 9 is formed by a first section 18 of the first part 7a, 8a and a first section 18 of the second part 7b, 8b of the respective busbar 7, 8. The first sections 18 each comprise to sub-sections that are perpendicular to each other. Thereby, a bend terminal 9 is formed. The bend terminal 9 has a subsection that is perpendicular to the lateral face 6c of the stack 6 and a sub-section that is parallel to the lateral face 6c.

The capacitor of the fifteenth embodiment has the same advantages as the capacitor of the fourteenth embodiment resulting from a large overlap of the busbars 7, 8 and from the arrangement of the winding elements 1 with alternating polarity.

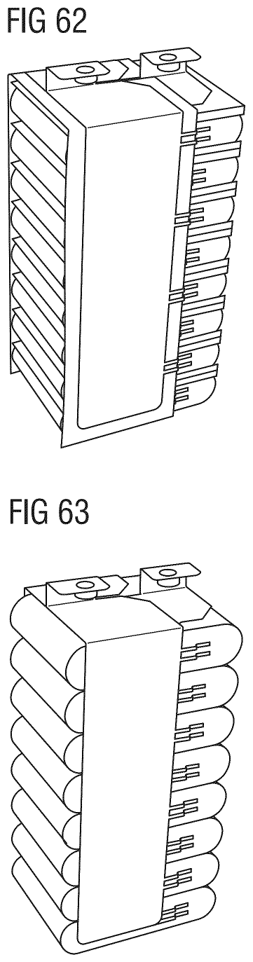

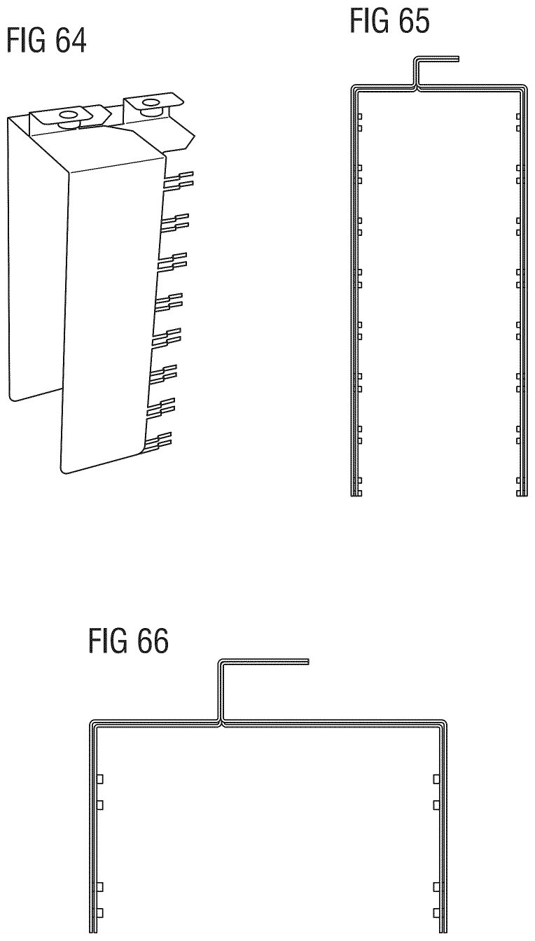

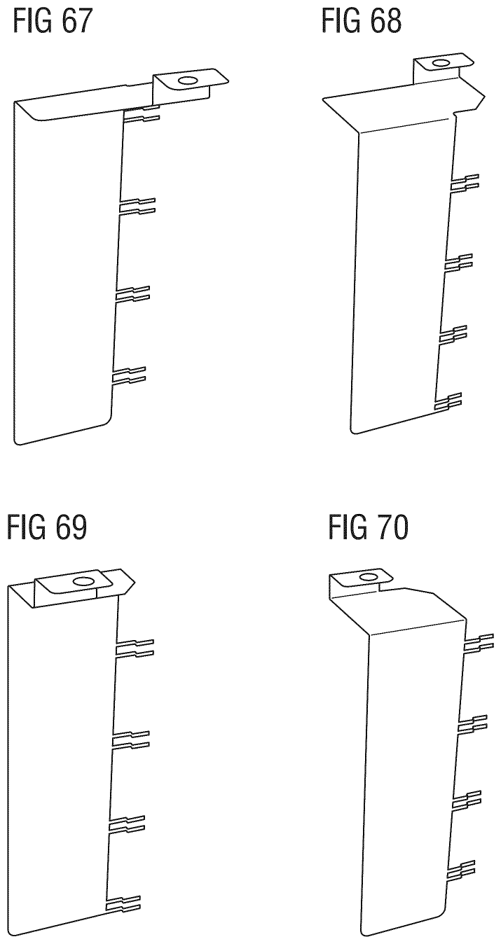

FIGS. 62 and 63 show a capacitor according to a sixteenth embodiment. FIG. 64 shows the busbars 7, 8 of the capacitor according to the sixteenth embodiment in a perspective view. FIG. 65 shows the busbars 7, 8 in a cross-sectional view. FIG. 66 shows an enlarged view of a part of FIG. 65. FIG. 67 shows a first part 7a of the first busbar 7. A second part 7b of the first busbar 7 is shown in FIG. 68. A first part 8a of the second busbar 8 is shown in FIG. 69. A second part 8b of the second busbar 8 is shown in FIG. 70.

The capacitor according to the sixteenth embodiment differs from the capacitor of the fifteenth embodiment in that the terminals 9 are arranged on the lateral face 6d. The surface normal of the lateral face 6d is parallel to the stacking direction S. In contrast to this, the terminals 9 of the capacitor of the fifteenth embodiment are arranged on the lateral face 6c wherein the surface normal of the lateral face 6c is perpendicular to the stacking direction S. The other features of the capacitor of the sixteenth embodiment are identical to the capacitor of the fifteenth embodiment. The capacitor of the sixteenth embodiment has the same advantages as the capacitor of the fourteenth embodiment and the capacitor of the fifteenth embodiment resulting from a large overlap of the busbars 7, 8 and from the arrangement of the winding elements 1 with alternating polarity.

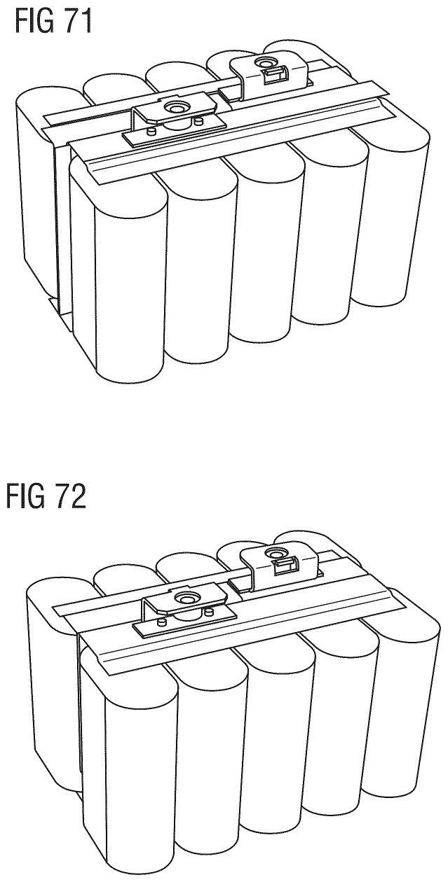

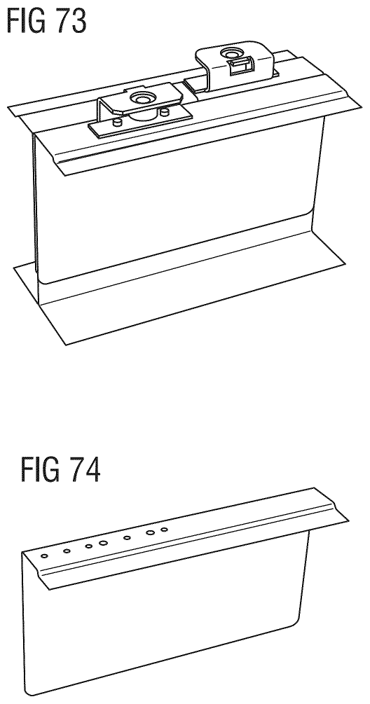

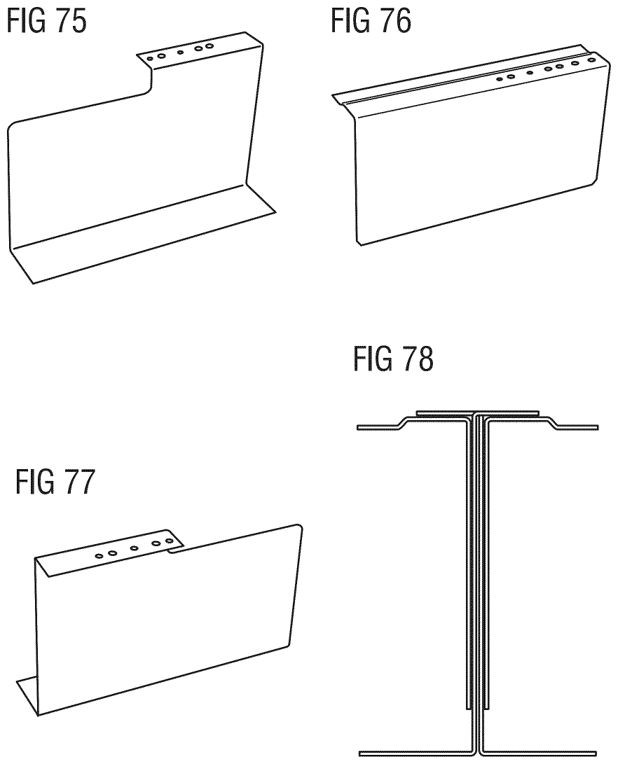

FIGS. 71 and 72 show a capacitor according to a seventeenth embodiment. FIG. 73 shows the busbars 7, 8 of the capacitor according to the seventeenth embodiment in a perspective view. FIG. 74 shows a first part 7a of the first busbar 7. A first part 8a of the second busbar 8 is shown in FIG. 75. A second part 8b of the second busbar 8 is shown in FIG. 76. A second part 7b of the first busbar 7 is shown in FIG. 77. FIG. 78 shows the busbars 7, 8 in a cross-sectional view.

The capacitor according to the seventeenth embodiment is similar to the capacitor of the twelfth embodiment and differs only in the design of the terminals 9. According to the seventeenth embodiment, the terminals 9 comprise a separate, hook-shaped element that is fixed to the busbars, e.g., by screwing. The hook-shaped element is electrically connected to the busbars 7, 8 and allows connecting the capacitor to further circuit elements.

The capacitor according to the seventeenth embodiment has four layers of overlapping busbars 7, 8 between the stacks 6, 13 of winding elements 1 such that the parasitic inductances are very low, the parasitic resistances are very low and negative electromagnetic interferences can be avoided. The busbars 7, 8 are connected to the middle points of the top face 3 or, respectively, the bottom face 2 of the winding elements 1, thus enabling a high current capability of the capacitor and the use of large winding elements.

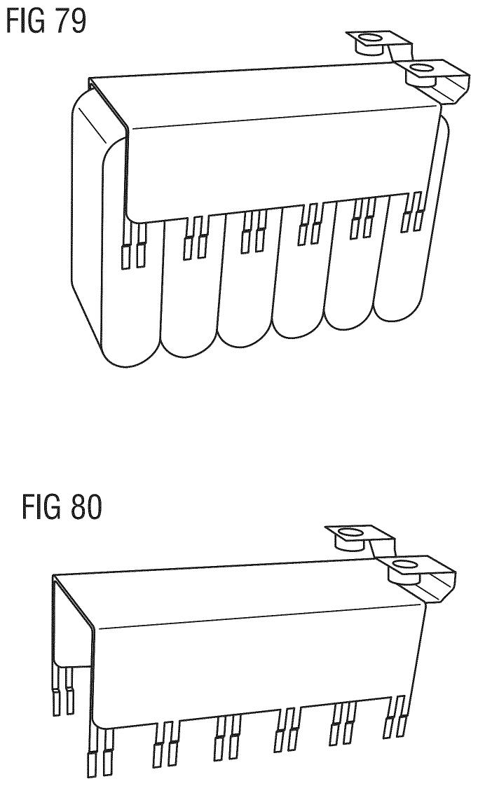

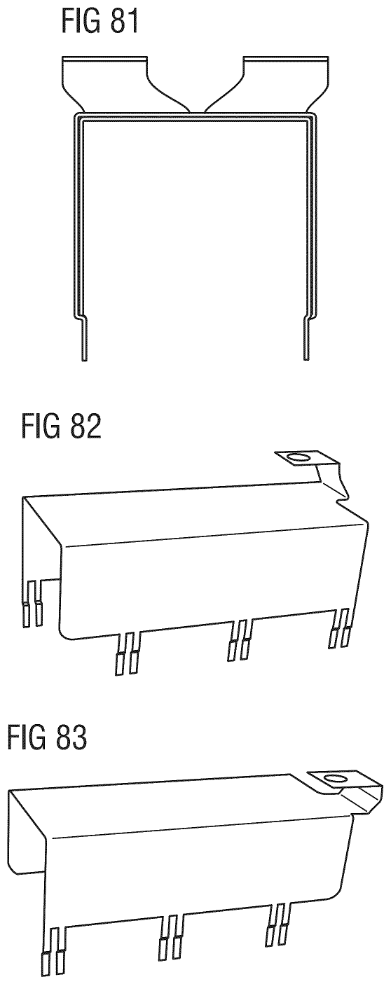

FIG. 79 shows a capacitor according to an eighteenth embodiment. FIG. 8o shows the busbars 7, 8 of the capacitor according to the eighteenth embodiment in a perspective view. FIG. 81 shows the busbars 7, 8 in a cross-sectional view.

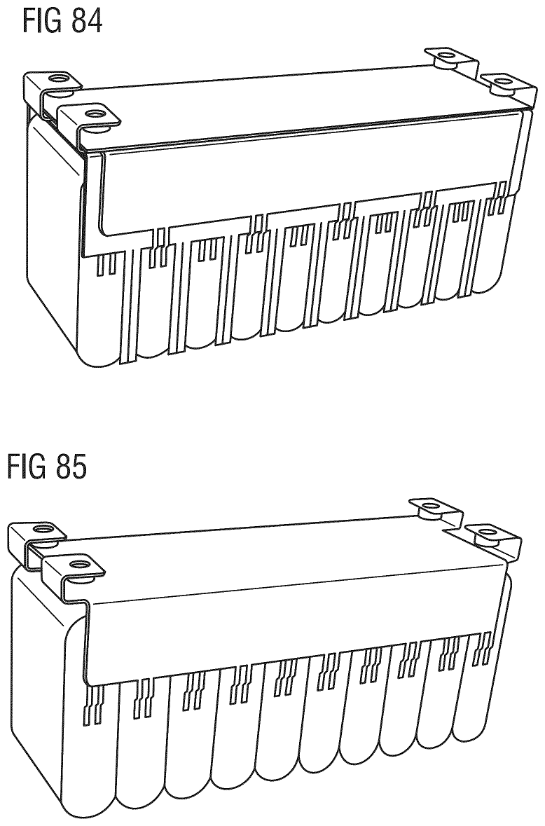

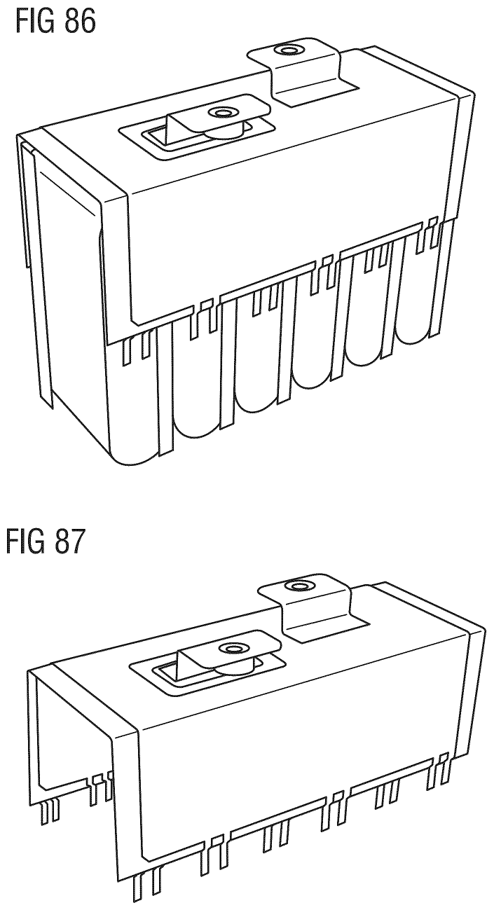

FIG. 82 shows the first busbar 7. FIG. 83 shows the second busbar 8.

The winding elements 1 are arranged in a single stack 6. Along the stacking direction S, the winding elements 1 are arranged such that their polarity alternates. Thus, each winding element 1 has an opposite polarity compared to its adjacent winding element 1. Due to the alternating winding polarities along the stacking directions S, parasitic inductances, the parasitic resistance and negative electromagnetic interactions are reduced compared to a capacitor wherein all winding elements 1 have the same polarities.

The capacitor comprises the first busbar 7 and the second busbar 8. Each busbar 7, 8 consists of one single piece or part. Thus, in contrast to the seventeenth embodiment, the busbars 7, 8 do not comprise multiple parts. Thus, the first busbar 7 is connected to each face of the winding elements 1 which has the first polarity and the second busbar 8 is connected to each face of the winding elements 1 which has the second polarity. As the busbars 7, 8 consist of a single piece, their design is simpler compared to busbars 7, 8 comprising multiple pieces.

When an AC current is applied to the terminals 9, the AC current flows through the entire busbars 7, 8.

The first busbar 7 and the second busbar 8 each have a U-shaped cross-section. In particular, they are arranged on the same faces of the stack 6 of winding elements 1 and overlap each other almost completely. Thus, the overlapping area of the two busbars 7, 8 is very large. Thus, the parasitic inductance and the parasitic resistance are low and negative electromagnetic interactions are avoided.

The busbars 7, 8 are connected to the middle point of the top face 3 of the winding elements 1 or, respectively, to the middle point of the bottom face 2 of the winding elements 1. This design of the busbars 7, 8 results in a capacitor having a large current capability. Moreover, the busbars 7, 8 can be adapted to a wide range of winding elements 1, thereby allowing for a large maximum size of the winding elements 1.

The first and the second busbar 7, 8 overlap with each other and the AC current flows in the busbars 7, 8 in opposite directions. Thus, the electromagnetic flux generated by the busbars 7, 8 cancels each other. This reduces parasitic inductances, parasitic resistances and negative electromagnetic interferences. Electromagnetic flux cancellation can be assured till the connection to the winding elements 1.

FIGS. 84 and 85 show a capacitor according to a nineteenth embodiment in a perspective view, wherein in FIG. 87 the isolator plates are not shown for visualization purposes. Compared to the eighteenth embodiment, the capacitor of the nineteenth embodiment comprises two additional terminals. Each of the first busbar 7 and the second busbar 8 has two terminals 9. In the stacking direction S, a first pair of terminals 9 is arranged at one end of the capacitor and a second pair of terminals 9 is arranged at the opposite end of the capacitor. This arrangement of the terminals 9 is optimized for the use of the capacitor in a back-to-back converter. The same capacitor can be connected to an inverter side and to a rectifier side.

The capacitor of the nineteenth embodiment has the same advantages as previously discussed with respect to the capacitor of the eighteenth embodiment.

FIG. 86 shows a capacitor of a twentieth embodiment and FIG. 87 shows the busbars 7, 8 of the capacitor of the twentieth embodiment. The capacitor of the twentieth embodiment differs from the capacitor of the eighteenth embodiment in the arrangement of the terminals 9. According to the twentieth embodiment, each of the first busbar 7 and the second busbar 8 comprises one terminal 9 wherein the terminal 9 is arranged centrally on the busbar 7, 8. The capacitor of the twentieth embodiment has the same advantages as previously discussed with respect to the capacitor of the eighteenth embodiment.

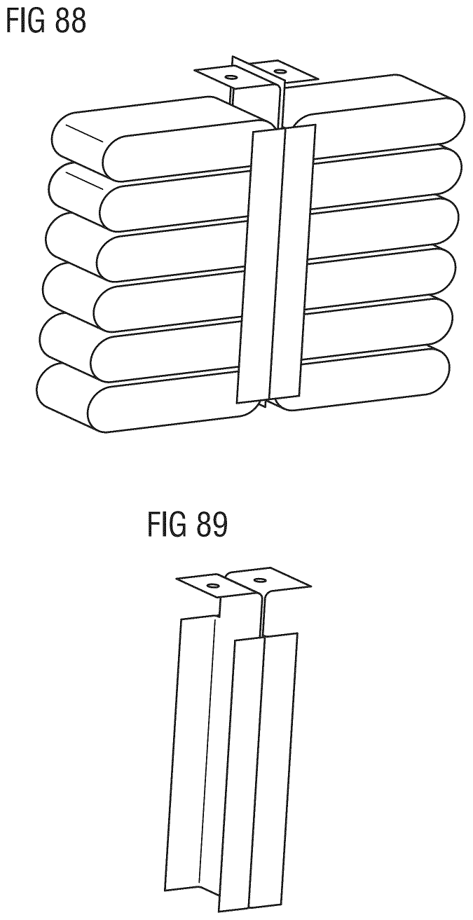

FIG. 88 shows a capacitor according to a twenty-first embodiment in a perspective view. FIGS. 89 to 92 show the busbars 7, 8 of the capacitor of the twenty-first embodiment.

The capacitor comprises a first stack 6 of winding elements 1 and a second stack 13 of winding elements 1. The winding elements 1 in the first stack 6 all have the same polarity and the winding elements 1 in the second stack 13 also all have the same polarity.

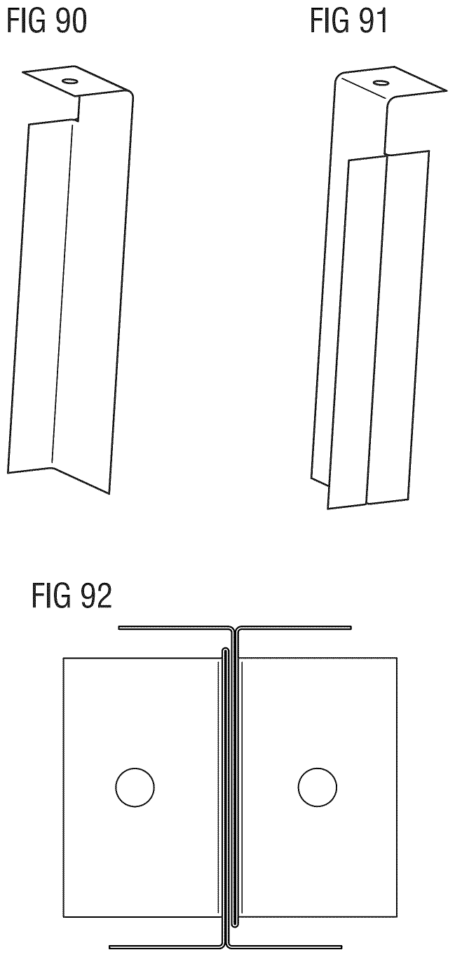

The busbars 7, 8 are arranged between the stacks 6, 13. Between the stacks 6, 13, the busbars 7, 8 overlap each other. Each of the first busbar 7 and the second busbar 8 has a double-L shape and is folded by 180° in its middle. The position of the folding 22 is marked in FIG. 92. Each of the first busbar 7 and the second busbar 8 comprises sections that are arranged between the stacks 6, 13 and sections that overlap with the top faces 3 or the bottom faces 2 of the winding elements 1. Due to the folding 22 of the busbars 7, 8, the busbars 7, 8 have a larger thickness in the sections between the stacks 6, 13 than in the sections overlapping with the top or bottom faces 2, 3. The increased thickness between the stacks 6, 13 results in a large current capability between the stacks 6, 13. As the busbars 7, 8 are thinner at the top or bottom faces 2, 3 of the winding elements 1, it is easy to fix the busbars 7, 8 to the winding elements 1 by welding.

No extra or separate connection elements between the winding elements 1 and the busbars 7, 8 are required. The busbars 7, 8 are fixed to the winding elements 1 directly, e.g., by welding or soldering. This reduces parasitic inductances, parasitic resistances and avoids negative electromagnetic interactions compared to a capacitor comprising separate connection elements.

As discussed above with respect to previous embodiments, the busbars 7, 8 are connected to the middle points of the top face 3 or, respectively, the bottom face 2 of the winding elements 1.

As the polarity of both stacks 6, 13 is not opposite, it is not required to interlace the connections between the busbars 7, 8 and the winding elements 1. Thus, a simple solution can be obtained.

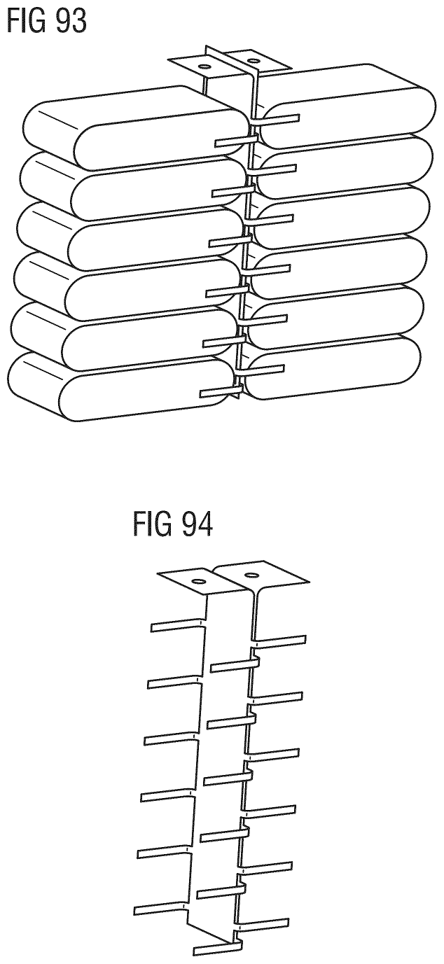

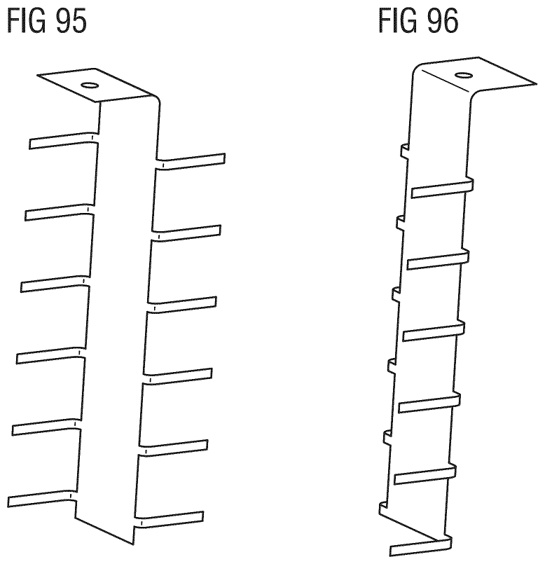

FIG. 93 shows a capacitor according to a twenty-second embodiment in a perspective view. FIGS. 94 to 96 show the busbars 7, 8 of the capacitor according to the twenty-second embodiment.

The capacitor of the twenty-second embodiment is similar to the capacitor of the sixth embodiment shown in FIGS. 19 and 20. The capacitor comprises two stacks 6, 13, each stack 6, 13 consisting of a plurality of winding elements 1. The winding elements 1 in the first stack 6 are arranged such that they are inverted in their polarity compared to the adjacent winding elements 1 in the second stack 13. In particular, the top face 3 of the winding elements 1 of the first stack 6 corresponds to the first pole and the top face 3 of the winding elements 1 of the second stack 13 corresponds to the second pole.

The design of the busbars 7, 8 of the capacitor of the twenty-second embodiment is different the capacitor of the sixth embodiment. The busbars 7, 8 are arranged between the stacks 6, 13 and comprise protrusions 21 overlapping the top face 3 or the bottom face 2 of the winding elements 1. The busbars 7, 8 are connected directly to the winding elements 1, e.g., by soldering or welding. The capacitor has a low parasitic inductance, a low parasitic resistance and negative electromagnetic interactions are avoided.

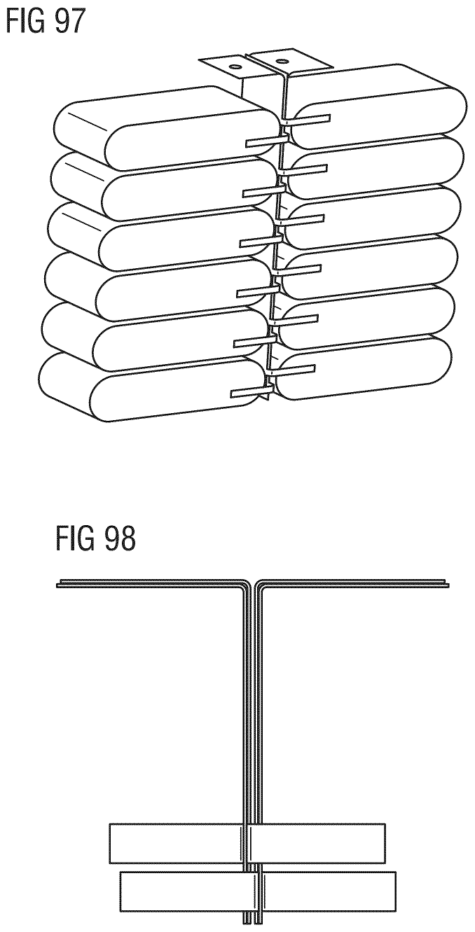

FIG. 97 shows a capacitor according to a twenty-third embodiment in a perspective view. FIG. 98 shows an enlarged view of a part of the first busbar and the second busbar.

The capacitor according to the twenty-third embodiment is similar to the capacitor of the twenty-second embodiment. In contrast to the twenty-second embodiment, the first busbar 7 and the second busbar 8 have a larger thickness in sections that are arranged between the two stacks 6, 13 than in sections that overlap the top face 3 or the bottom face 2 of a winding element 1. This larger thickness is achieved by folding each of the busbars 7, 8 in the sections between the stacks 6, 13.

The current capability is high due to the large thickness of the busbars 7, 8 between the stacks 6, 13. A welding process is easy as the sections of the busbars 7, 8 that overlap the top face 3 or the bottom face 2 of the winding elements 1 have a low thickness.

The busbars 7, 8 can be connected to the winding elements 1 directly, i.e., without extra connection elements, e.g., by welding or soldering. Thereby, it is ensured that parasitic inductances are low, parasitic resistance is low and negative electromagnetic interaction is avoided.

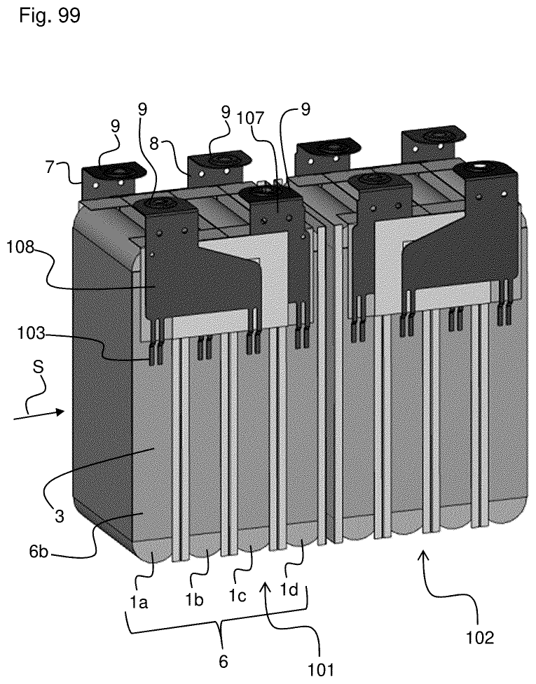

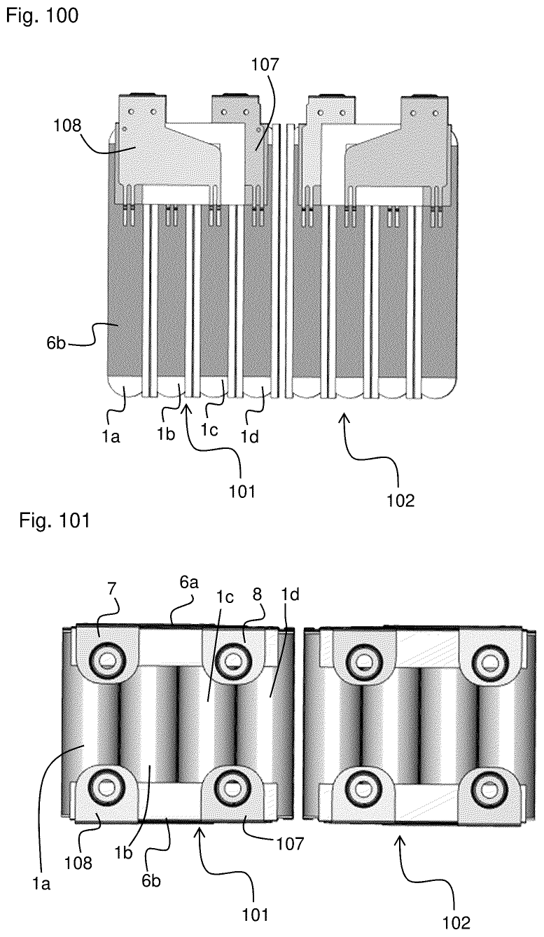

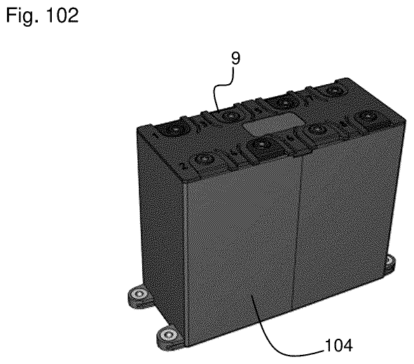

FIG. 99 shows a perspective view of a twenty-fourth embodiment of the capacitor. FIG. 100 shows a side view of the capacitor according to the twenty-fourth embodiment. FIG. 101 shows a top view of the capacitor according to the twenty-fourth embodiment. FIG. 102 shows the capacitor of the twenty-fourth embodiment wherein the capacitor units are enclosed in an encapsulation. In FIGS. 99, 100 and 101, the encapsulation is not shown for a better illustration of the other features.

The capacitor according to the twenty-fourth embodiment comprises two capacitor units 101, 102. In the following, the first capacitor unit 101 is described. The second capacitor unit 102 is constructed identically. Each capacitor unit 101, 102 comprises four winding elements arranged in a single stack 6, i.e. a first winding element 1a, a second winding element 1b, a third winding element 1c and a fourth winding element 1d. The winding elements 1a-1d in the stack 6 are arranged such that the top faces 3 of the winding elements form a first lateral face 6a of the stack 6 and the bottom faces 2 of the winding elements 1a-1d form a second lateral face 6b of the stack 6. The second lateral face 6b is opposite of the first lateral face 6a. A stacking direction S of the stack 6 is perpendicular to a surface normal of the first lateral face 6a and the stacking direction S of the stack 6 is perpendicular to a surface normal of the second lateral face 6b.

Each capacitor unit comprises a first busbar 7, a second busbar 8, a third busbar 107 and a fourth busbar 108. The first busbar 7 and the second busbar 8 are arranged on the first lateral face 6a of the stack. The first busbar 7 and the second busbar 8 overlap each other. The third busbar 107 and the fourth busbar 108 are arranged on the second lateral face 6b of the stack. The third busbar 107 and the fourth busbar 108 overlap each other. In the area of the overlap of the busbars 7, 8, 107, 108, a thin isolator is arranged between the busbars which prevents a short circuit between the busbars. Due to the overlap of the first busbar 7 and the second busbar 8 and, respectively, the overlap of the third busbar 107 and the fourth busbar 108, a capacitor unit is provided which has a characteristic that is well suited for power applications. When a current flows through the first busbar 7, a magnetic field is generated by the current. Further, when a current flows through the second busbar 8, another magnetic field is generated by this current. Due to the overlap of the first busbar 7 and the second busbar 8, the magnetic fields have opposite orientations and, therefore, weaken or even cancel each other. Analogously, due to the overlap of the third busbar 107 and the fourth busbar 108, the magnetic fields generated by currents flowing through the third busbar and the fourth busbar have opposite orientations and, therefore, weaken or even cancel each other. Thus, overall, only a very weak magnetic field is generated, when a current is applied to the busbars. This results in a small inductance of the connection of the busbars 7, 8, 107, 108 and between the winding elements 1s-1d. Thus, the inductance of the capacitor unit is very small.

A capacitor with overlapping busbars has a low equivalent series resistance (ESR), a frequency-stable ESR, a low equivalent series inductance (ESL), and a homogeneous internal current distribution. Internal resonances may be avoided.

The first winding element 1a is the outermost winding element of the stack 6. The second winding element 1b is adjacent to the first winding element 1a in the stacking direction S. The third winding element 1c is adjacent to the second winding element 1b in the stacking direction S. The fourth winding element 1d is adjacent to the third winding element 1c in the stacking direction S. The fourth winding element 1d is the last winding element of the stack 6 of the first capacitor unit 101.

The first busbar 7 is connected to the top face 2 of the first winding element 1a and the fourth busbar 108 is connected to the bottom face 3 of the first winding element 1a. The second busbar 8 is connected to the top face 2 of the second winding element 1b and the third busbar 107 is connected to the bottom face 3 of the second winding element 1b. The first busbar 7 is connected to the top face 2 of the third winding element 1c and the fourth busbar 108 is connected to the bottom face 3 of the third winding element 1c. The second busbar 8 is connected to the top face 2 of the fourth winding element 1d and the third busbar 107 is connected to the bottom face 3 of the fourth winding element 1d.

Each busbar comprises a terminal 9 which is configured to be connected to an external connection. Thus, each of the capacitor units 101, 102 comprises four terminals 9. Due to the rather large number of four terminals 9 per capacitor unit, the self-inductance of the capacitor unit is very small and, thereby, the self-inductance of the entire capacitor is also very small.

Via the external connection, a first potential can be applied to the first busbar 7 and to the third busbar 107. Via the external connection, an opposite potential can be applied to the second busbar 8 and to the fourth busbar 108. In this case, a current flows through adjacent winding elements in an opposite direction.

Thereby, the polarities of the winding elements 1a-1d alternate along the stacking direction S. In other words, in the stacking direction, each winding element has an opposite polarity compared to the adjacent winding element.

As a result, the magnetic flux is compensated in all connections, including the connection between winding elements 1s-1d. This results in only very small parasitic inductances and resistances between winding elements 1a-1d and between winding elements 1a-1d and terminals 9. By reducing the parasitic inductances and resistances, the impedance from the terminals to each winding is more homogeneous between the winding elements for each frequency in the bandwidth in which the capacitor is operated. Thus, the performance of the capacitor in the complete bandwidth is better due to a low and frequency stable ESR, a low ESL from each pair of terminals, an homogeneous internal current distribution and the avoidance of internal resonances.

Each busbar 7, 8, 107, 108 comprises at least two tabs 103. Each busbar is connected to a top face 2 or, respectively, to a bottom face 3 of the respective winding element 1a-1d by at at least one tabs 103. Each tab 103 defines a connection point at which the winding element 1a-1d and the busbar 7, 8, 107, 108 are connected. Thus, the busbars 7, 8, 107, 108 are connected to the respective top faces 2 or bottom faces 3. For example, the first busbar 7 is connected to the top face 2 of the first winding element 1a by at least one tabs 103 at least one connection point and, further, the first busbar 7 is connected to the top face 2 of the third winding element 1c by at least one tab 103 at least one connection point.

Each busbar 7, 8, 107, 108 comprises a substantially flat metal plate with tabs 103 being arranged at a lower end and the terminal 9 being arranged at the upper end. The terminal 9 is bend by 90° relative to the flat metal plate.

In the embodiment shown in FIGS. 99 to 102, the capacitor comprises two identical capacitor units 101, 102. In alternate embodiments, the number of capacitor units can be different. For example, the capacitor may comprise only a single capacitor unit 101. Alternatively, the capacitor may comprise three or more capacitor units.

The capacitor further comprises an encapsulation 104. The encapsulation encloses all capacitor units 101, 102 of the capacitor such that only the terminals 9 protrude from the encapsulation 104.

For all the embodiments described above, the quantity of the winding elements 1 per capacitor can be varied. The shape and the dimensions of the winding elements 1 can also be varied in all of the above described embodiments. The terminal 9 layout can also be varied in each of the embodiments.

1. A capacitor comprising:
at least one capacitor unit, each capacitor unit comprising
at least two winding elements, a first busbar, a second busbar, a third busbar and a fourth busbar,
wherein all winding elements of the capacitor unit are arranged in a single stack,
wherein the first busbar and the second busbar are arranged such that they overlap each other,
wherein the first busbar and the second busbar are arranged at a first lateral face of the stack which has a surface normal perpendicular to a stacking direction of the stack,
wherein, in the stacking direction, alternatingly either the first busbar or the second busbar is connected to a top face of the winding elements,
wherein the third busbar and the fourth busbar are arranged such that they overlap each other,
wherein the third busbar and the fourth busbar are arranged on a second lateral side of the stack opposite to a first lateral side, and
wherein, in the stacking direction, alternatingly either the third busbar or the fourth busbar is connected to a bottom face of the winding elements, such that the third busbar is connected to the bottom faces of the winding elements which have a top face that is connected to the second busbar and that the fourth busbar is connected to the top faces of the winding elements which have a bottom face that is connected to the first busbar.

2. The capacitor according to claim 1,
wherein the first busbar and the second busbar are arranged such that at least 20% of an area of the first busbar is overlapped by the second busbar,
and
wherein the third busbar and the fourth busbar are arranged such that at least 20% of an area of the third busbar is overlapped by the fourth busbar.

3. The capacitor according to claim 1,
wherein the first busbar and the second busbar are arranged such that a current flowing through the first busbar generates a first magnetic field and a current flowing through the second busbar generates a second magnetic field, wherein the first magnetic field and the second magnetic field compensate each other,
wherein the third busbar and the fourth busbar are arranged such that a current flowing through the third busbar generates a third magnetic field and a current flowing through the fourth busbar generates a fourth magnetic field, and wherein the third magnetic field and the fourth magnetic field compensate each other.

4. The capacitor according to claim 1,
wherein each winding element has a “A” pole and a “B” pole,
wherein the “A” poles of each winding element are connected either to the first busbar or to the third busbar, and
wherein the “B” poles of each winding element are connected either to the second busbar or to the fourth busbar.

5. The capacitor according to claim 1, wherein each of the busbars is connected to the winding elements directly.

6. The capacitor according to claim 1, wherein each busbar of the capacitor unit is connected to the top face or to the bottom face of the respective winding element.

7. The capacitor according to claim 1, wherein each busbar comprises a terminal which is configured to be connected to an external connection.

8. The capacitor according to claim 1, wherein, in the stacking direction of the stack, each winding element has an opposite polarity compared to the adjacent winding element.

9. The capacitor according to claim 1, wherein the winding elements are arranged in the stack such that the top faces of the winding elements are arranged at the first lateral side of the stack and the bottom faces of the winding elements are arranged at the second lateral side of the stack.

10. The capacitor according to claim 1, wherein the winding elements have a non-circular diameter.

11. The capacitor according to claim 1, further comprising an encapsulation which encloses the capacitor unit.

12. A capacitor
comprising:
two or more capacitor units,
each capacitor unit comprises at least two winding elements, a first busbar, a second busbar, a third busbar and a fourth busbar,
wherein all winding elements of each capacitor unit are arranged in a single stack,
wherein the first busbar and the second busbar are arranged such that they overlap each other,
wherein the first busbar and the second busbar are arranged at a first lateral face of the stack which has a surface normal perpendicular to a stacking direction of the stack,
wherein, in the stacking direction, alternatingly either the first busbar or the second busbar is connected to a top face of the winding elements,
wherein the third busbar and the fourth busbar are arranged such that they overlap each other,
wherein the third busbar and the fourth busbar are arranged on a second lateral side of the stack opposite to a first lateral side, and
wherein, in the stacking direction, alternatingly either the third busbar or the fourth busbar is connected to a bottom face of the winding elements, such that the third busbar is connected to the bottom faces of the winding elements which have a top face that is connected to the second busbar and that the fourth busbar is connected to the top faces of the winding elements which have a bottom face that is connected to the first busbar.

13. The capacitor according to claim 12, wherein the two or more capacitor units are arranged such that the stacks of winding elements of each of the two or more capacitor units are arranged in one or more rows, and wherein the stacking directions of the stacks are parallel to each other.

14. The capacitor according to claim 12, further comprising an encapsulation which encloses the capacitor units.

15. The capacitor according to claim 12, wherein, in each capacitor unit, each busbar of the capacitor unit is connected to the top face or to the bottom face of the respective winding element.

16. The capacitor according to claim 12, wherein each busbar comprises a terminal which is configured to be connected to an external connection.
